(19) United States
(12) Patent Application Publication
(10) Pub. No.: US 2026/0235910 A1
(43) Pub. Date: Aug. 13, 2026

(54) LIQUID CRYSTAL DISPLAY DEVICE

(71) Applicant: Sharp Display Technology Corporation, Kameyama City (JP)

(72) Inventors: Kentaroh IRIE, Kameyama City (JP); Mitsuaki HIRATA, Kameyama City (JP); Masae KITAYAMA, Kameyama City (JP)

(21) Appl. No.: 19/535,229

(22) Filed: Feb. 10, 2026

(30) Foreign Application Priority Data
Feb. 13, 2025 (JP) 2025-021411

(51) Int. Cl. G02F 1/1337; G02F 1/1343; G02F 1/1362; G02F 1/1368

(52) U.S. Cl. CPC G02F 1/133742; G02F 1/133788; G02F 1/134336; G02F 1/134345; G02F 1/136286; G02F 1/1368

(57) ABSTRACT

A liquid crystal display device includes a first substrate, a second substrate, and a vertically aligned liquid crystal layer. The first substrate includes a gate wiring line, a source wiring line, and a pixel electrode. Pixels each include a first subpixel and a second subpixel. The pixel electrode includes a first subpixel electrode and a second subpixel electrode. The first substrate includes a first TFT connected to the first subpixel electrode, a second TFT connected to the second subpixel electrode, a third TFT connected to the second TFT and the second subpixel electrode, and a discharge wiring line connected to the third TFT. The pixel electrode includes a slit at least partially overlapping the discharge wiring line in a plan view. The first substrate or the second substrate includes a light blocking layer including a light blocking portion arranged so as to at least partially overlap the slit in a plan view.

### CROSS-REFERENCE TO RELATED APPLICATIONS

This application claims the benefit of priority to Japanese Patent Application Number 2025-021411 filed on Feb. 13, 2025. The entire contents of the above-identified application are hereby incorporated by reference.

### BACKGROUND

### Technical Field

The disclosure relates to a liquid crystal display device, and in particular, relates to a liquid crystal display device including a vertically aligned liquid crystal layer.

An alignment division structure in which a plurality of liquid crystal domains are formed in one pixel is known as a technique for improving viewing angle characteristics of a liquid crystal display device using a vertical alignment (VA) mode. In recent years, as a method of forming an alignment division structure, a 4D-reverse twisted nematic (RTN) mode has been proposed.

In the 4D-RTN mode, an alignment division structure is formed by using an alignment film to define a pretilt direction of liquid crystal molecules. For example, WO 2006/132369 discloses a liquid crystal display device using the 4D-RTN mode. In the liquid crystal display device disclosed in WO 2006/132369, a four-domain alignment structure is formed by using an alignment film to define pretilt directions. That is, when a voltage is applied to a liquid crystal layer, four liquid crystal domains are formed in one pixel. Such a four-domain alignment structure may be simply referred to as a 4D structure.

In the 4D-RTN mode, a pretilt direction defined by one alignment film of a pair of alignment films facing each other with the liquid crystal layer interposed therebetween is different by about 90° from a pretilt direction defined by the other alignment film. Thus, when a voltage is applied, the liquid crystal molecules shift to a twist alignment. As can be understood from the disclosed content in WO 2006/132369, in the 4D-RTN mode, typically four liquid crystal domains are arranged in two rows and two columns in a pixel.

In a liquid crystal display device using the 4D-RTN mode, as described in WO 2006/132369, a dark line (a region darker than other regions) is formed in the pixel when a voltage is applied. The dark line causes a decrease in transmittance (a decrease in light utilization efficiency). The general shape of the region in which the dark line is generated varies depending on an alignment division pattern. However, whichever pattern is adopted, the shape includes a portion in the shape of a cross corresponding to a boundary between liquid crystal domains (hereinafter, also referred to as a “domain boundary”). In order to suppress a decrease in transmittance due to the dark line, WO 2018/138888 proposes forming a slit in a region of a pixel electrode located in the vicinity of a domain boundary.

In recent years, a “pixel division drive technique” has been put into practical use as a technique used for improving the viewing angle characteristics of a liquid crystal display device in the VA mode. According to the pixel division drive technique, a problem in which the y (gamma) characteristic when observed from a front direction is different from the y characteristic when observed from an oblique direction is improved, that is, the viewing angle dependence of the y characteristic is improved. The y characteristic is the gray scale dependence of the display luminance.

In the pixel division drive technique, one pixel is constituted by a plurality of subpixels in which different voltages can be applied to a liquid crystal layer. That is, the plurality of subpixels can exhibit different luminance, and a predetermined luminance corresponding to a display signal voltage input to the pixel is realized in general by the one pixel. That is, the pixel division drive technique is a technique in which the different y characteristics of the plurality of subpixels are combined to improve the viewing angle dependence of the y characteristic of the pixel.

Several known methods can be used as the pixel division drive technique. One of these methods is disclosed in U.S. Pat. No. 9,958,739. Herein, a method used in the pixel division drive technique disclosed in U.S. Pat. No. 9,958,739 is referred to as a “discharge method”.

FIG. 22 illustrates an equivalent circuit of a pixel P in a case in which the discharge method is adopted. Note that, in FIG. 22, an auxiliary capacitor is omitted in order to simplify the description. As illustrated in FIG. 22, the pixel P includes a first subpixel Sp1 and a second subpixel Sp2.

The first subpixel Sp1 includes a first liquid crystal capacitor Clc1 including a first subpixel electrode, and a first TFT tr1. A gate electrode of the first TFT tr1 is electrically connected to a gate wiring line GL and supplied with a gate signal from the gate wiring line GL. A source electrode of the first TFT tr1 is electrically connected to a source wiring line SL and supplied with a source signal from the source wiring line SL. A drain electrode of the first TFT tr1 is electrically connected to the first subpixel electrode.

The second subpixel Sp2 includes a second TFT tr2, a third TFT tr3, and a second liquid crystal capacitor Clc2 including a second subpixel electrode. A gate electrode of the second TFT tr2 is electrically connected to the gate wiring line GL and supplied with a gate signal from the gate wiring line GL.

A source electrode of the second TFT tr2 is electrically connected to the source wiring line SL and supplied with a source signal from the source wiring line SL. A drain electrode of the second TFT tr2 is electrically connected to the second subpixel electrode. A gate electrode of the third TFT tr3 is electrically connected to the gate wiring line GL and supplied with a gate signal from the gate wiring line GL. A source electrode of the third TFT tr3 is electrically connected to the drain electrode of the second TFT tr2 and the second subpixel electrode. A drain electrode of the third TFT tr3 is electrically connected to a discharge wiring line (referred to as a “reference voltage wiring line” in U.S. Pat. No. 9,958,739) DcL.

When the gate signal supplied by the gate wiring line GL changes from a low level to a high level, the first TFT tr1, the second TFT tr2, and the third TFT tr3 are turned on. Thus, the source signal is supplied from the source wiring line SL to the first subpixel electrode and the second subpixel electrode via the first TFT tr1 and the second TFT tr2, respectively, and the first liquid crystal capacitor Clc1 and the second liquid crystal capacitor Clc2 are charged. At this time, in the second subpixel Sp2, voltage division is performed in accordance with the ratio between the on-resistance of the second TFT tr2 and the on-resistance of the third TFT tr3. Thus, the voltage applied to the second liquid crystal capacitor Clc2 is lower than the voltage applied to the first liquid crystal capacitor Clc1. Therefore, the first subpixel Sp1 can be caused to function as a bright subpixel that is relatively bright, and the second subpixel Sp2 can be caused to function as a dark subpixel that is relatively dark.

### SUMMARY

The inventors of the present application have adopted the configuration proposed in WO 2018/138888 (a configuration in which a slit is formed in the vicinity of the domain boundary of pixel electrodes) in a liquid crystal display device using a 4D-RTN mode, and further studied the combination with a pixel division drive technique using a discharge method. As a result of the study, the inventors have found that, as described in detail later, light leakage may occur in the vicinity of the slit depending on the arrangement of the discharge wiring line, and the contrast ratio may decrease.

The disclosure has been contrived in view of the above-described problems, and an object of the disclosure is to suppress a decrease in contrast ratio in a liquid crystal display device using a VA mode in which a discharge wiring line is arranged so as to at least partially overlap a slit formed in a pixel electrode.

The present specification discloses a liquid crystal display device according to the following items.

### [Item 1]

A liquid crystal display device including
a first substrate and a second substrate facing each other,
a vertically aligned liquid crystal layer provided between the first substrate and the second substrate, and
a plurality of pixels arrayed in a matrix shape including a plurality of pixel rows and a plurality of pixel columns, in which
the first substrate includes a gate wiring line that supplies a gate signal to a corresponding pixel row among the plurality of pixel rows, a source wiring line that supplies a source signal to a corresponding pixel column among the plurality of pixel columns, and a pixel electrode provided in each of the plurality of pixels,
the second substrate includes a counter electrode facing the pixel electrode,
each of the plurality of pixels includes a first subpixel and a second subpixel in which different voltages can be applied to the vertically aligned liquid crystal layer,
the pixel electrode includes a first subpixel electrode provided in the first subpixel and a second subpixel electrode provided in the second subpixel,
the first substrate includes
a first TFT electrically connected to the gate wiring line, the source wiring line, and the first subpixel electrode,
a second TFT electrically connected to the gate wiring line, the source wiring line, and the second subpixel electrode,
a third TFT electrically connected to the gate wiring line, the second TFT, and the second subpixel electrode, and
a discharge wiring line electrically connected to the third TFT,
the pixel electrode includes at least one slit that at least partially overlaps the discharge wiring line in a plan view, and
the first substrate or the second substrate includes a light blocking layer including a light blocking portion that at least partially overlaps the at least one slit in a plan view.

### [Item 2]

The liquid crystal display device according to item 1, in which the at least one slit includes a portion overlapping both the light blocking portion and the discharge wiring line in a plan view, and a portion overlapping the light blocking portion and not overlapping the discharge wiring line in a plan view.

### [Item 3]

The liquid crystal display device according to item 1 or 2, in which a potential applied to the discharge wiring line is different from a potential applied to the counter electrode.

### [Item 4]

The liquid crystal display device according to any one of items 1 to 3, in which the first substrate includes the light blocking layer.

### [Item 5]

The liquid crystal display device according to item 4, in which the light blocking layer is formed of a conductive material and a predetermined potential is applied to the light blocking layer.

### [Item 6]

The liquid crystal display device according to item 5, in which the first substrate further includes an auxiliary capacitor wiring line, and
the predetermined potential applied to the light blocking layer is identical to a potential applied to the auxiliary capacitor wiring line.

### [Item 7]

The liquid crystal display device according to any one of items 4 to 6, in which the discharge wiring line is formed in an identical layer to the source wiring line, and the light blocking layer is formed in an identical layer to the gate wiring line.

### [Item 8]

The liquid crystal display device according to any one of items 1 to 7, in which the first substrate further includes a first alignment film provided between the pixel electrode and the liquid crystal layer,
the second substrate further includes a second alignment film provided between the counter electrode and the liquid crystal layer,
each of the first subpixel and the second subpixel includes a plurality of liquid crystal domains having different reference alignment directions defined by the first alignment film and the second alignment film,
the plurality of liquid crystal domains include a first liquid crystal domain in which the reference alignment direction is a first direction, a second liquid crystal domain in which the reference alignment direction is a second direction, a third liquid crystal domain in which the reference alignment direction is a third direction, and a fourth liquid crystal domain in which
the reference alignment direction is a fourth direction, the at least one slit includes at least one first slit extending substantially parallel to the first direction, the at least one first slit being located at or near a first boundary that is a boundary between the first liquid crystal domain and another one of the plurality of liquid crystal domains, and
the discharge wiring line overlaps the first boundary in a plan view.

### [Item 9]

The liquid crystal display device according to item 8, in which the light blocking layer extends in a direction substantially identical to a direction in which the discharge wiring line extends,
the discharge wiring line includes a first wiring line edge and a second wiring line edge that define a width of the discharge wiring line, the first wiring line edge being located relatively closer to the first liquid crystal domain, and the second wiring line edge being located relatively closer to the other one of the plurality of liquid crystal domains,
the light blocking portion includes a first light blocking layer edge and a second light blocking layer edge that define a width of the light blocking portion, the first light blocking layer edge being located relatively closer to the first liquid crystal domain, and the second light blocking layer edge being located relatively closer to the other one of the plurality of liquid crystal domains, and
the first wiring line edge is located between the first boundary and the first light blocking layer edge.

### [Item 10]

The liquid crystal display device according to item 9, in which the light blocking portion is disposed such that a center of the light blocking portion in a width direction is shifted further to the first wiring line edge than a center of the discharge wiring line in the width direction in a plan view.

### [Item 11]

The liquid crystal display device according to item 9 or 10, in which a distance from the first wiring line edge to the first light blocking layer edge in a plan view is 1.4 μm or greater.

### [Item 12]

The liquid crystal display device according to any one of items 9 to 11, in which the distance from the first wiring line edge to the first light blocking layer edge in a plan view is 4.0 μm or less.

### [Item 13]

The liquid crystal display device according to any one of items 8 to 12, in which the at least one first slit includes a first long slit and at least one first short slit shorter than the first long slit.

### [Item 14]

The liquid crystal display device according to item 13, in which each of the at least one first short slit entirely overlaps the light blocking portion in a plan view, and the first long slit includes a portion overlapping the light blocking portion and a portion not overlapping the light blocking portion in a plan view.

### [Item 15]

The liquid crystal display device according to any one of items 8 to 14, in which the first liquid crystal domain, the second liquid crystal domain, the third liquid crystal domain, and the fourth liquid crystal domain are arranged in two rows and two columns,
the first liquid crystal domain and the second liquid crystal domain are adjacent to each other in an oblique direction inclined with respect to a row direction and a column direction,
the pixel electrode includes at least one second slit formed in a region corresponding to the second liquid crystal domain, the at least one second slit extending substantially parallel to the second direction and being located at or near a second boundary that is a boundary between the second liquid crystal domain and another one of the plurality of liquid crystal domains,
the discharge wiring line also overlaps the second boundary in a plan view, and
the light blocking layer includes a further light blocking portion that at least partially overlaps the at least one second slit in a plan view.

### [Item 16]

The liquid crystal display device according to item 15, in which the third liquid crystal domain is adjacent to the first liquid crystal domain in the row direction and adjacent to the second liquid crystal domain in the column direction,
the fourth liquid crystal domain is adjacent to the first liquid crystal domain in the column direction and adjacent to the second liquid crystal domain in the row direction,
the first boundary is a boundary between the first liquid crystal domain and the third liquid crystal domain, and
the second boundary is a boundary between the second liquid crystal domain and the fourth liquid crystal domain.

### [Item 17]

The liquid crystal display device according to any one of items 8 to 16, in which the first direction, the second direction, the third direction, and the fourth direction are four directions in which a difference between any two directions is substantially equal to an integer multiple of 90°.

### [Item 18]

The liquid crystal display device according to any one of items 8 to 17, in which the first direction and the second direction form an angle of about 180°.

### [Item 19]

The liquid crystal display device according to any one of items 8 to 18, in which each of the first alignment film and the second alignment film is a photo-alignment film.

According to the embodiment of the disclosure, a decrease in contrast ratio can be suppressed in a liquid crystal display device using a VA mode in which a discharge wiring line is arranged so as to at least partially overlap a slit formed in a pixel electrode.

### BRIEF DESCRIPTION OF DRAWINGS

The disclosure will be described with reference to the accompanying drawings, wherein like numbers reference like elements.

FIG. 1 is a diagram illustrating an alignment division structure of a pixel 900P in a typical liquid crystal display device using a 4D-RTN mode.

FIG. 2A is a diagram for describing a method of obtaining an alignment division structure of the pixel 900P, and illustrates pretilt directions PD1 and PD2 defined by an alignment film provided on an active matrix substrate.

FIG. 2B is a diagram for describing a method of obtaining an alignment division structure of the pixel 900P, and illustrates pretilt directions PD3 and PD4 defined by an alignment film provided on a counter substrate.

FIG. 2C is a diagram for describing a method of obtaining an alignment division structure of the pixel 900P, and illustrates tilt directions (directors) when a voltage is applied to a liquid crystal layer after the active matrix substrate and the counter substrate are bonded together.

FIG. 3 is a diagram schematically illustrating an alignment state of liquid crystal molecules 931 in the pixel 900P.

FIG. 4 is a plan view illustrating an alignment state of the liquid crystal molecules 931 in the vicinity of an edge SD1 of a pixel electrode 911.

FIG. 5A is a cross-sectional view schematically illustrating a liquid crystal display device 100 according to an embodiment of the disclosure, and illustrates a cross section along a line 5A-5A′ in FIG. 8.

FIG. 5B is a cross-sectional view schematically illustrating the liquid crystal display device 100 and illustrates a cross section along a line 5B-5B′ in FIG. 8.

FIG. 6 is a diagram illustrating an alignment division structure of a pixel P in the liquid crystal display device 100.

FIG. 7 is an equivalent circuit diagram of the pixel P in the liquid crystal display device 100.

FIG. 8 is a plan view schematically illustrating the liquid crystal display device 100 and illustrates a region corresponding to one pixel P.

FIG. 9 is a plan view schematically illustrating a pixel electrode 11 in the liquid crystal display device 100 and also illustrates a domain arrangement.

FIG. 10A is a cross-sectional view illustrating a liquid crystal display device 1000 in a comparative example, and illustrates a cross section along a line 10A-10A′ in FIG. 11.

FIG. 10B is a cross-sectional view illustrating the liquid crystal display device 1000, and illustrates a cross section along a line 10B-10B′ in FIG. 11.

FIG. 11 is a plan view illustrating the liquid crystal display device 1000 and illustrates a region corresponding to one pixel P.

FIG. 12 is a diagram illustrating a result obtained by simulating a transmittance distribution in a second subpixel Sp2 during black display in the liquid crystal display device 1000 of a comparative example.

FIG. 13 is a diagram illustrating a result obtained by an alignment simulation of a transmittance distribution in the second subpixel Sp2 during black display in the liquid crystal display device 100.

FIG. 14A is a cross-sectional view schematically illustrating another liquid crystal display device 200 according to an embodiment of the disclosure, and illustrates a cross section along a line 14A-14A′ in FIG. 15.

FIG. 14B is a cross-sectional view schematically illustrating the liquid crystal display device 200, and illustrates a cross section along a line 14B-14B′ in FIG. 15.

FIG. 15 is a plan view schematically illustrating the liquid crystal display device 200 and illustrates a region corresponding to one pixel P.

FIG. 16 is a diagram illustrating a result obtained by an alignment simulation of a transmittance distribution in the second subpixel Sp2 during black display in the liquid crystal display device 200.

FIG. 17 is a diagram illustrating a state in which a first long slit s1A and a first short slit s1B overlap a discharge wiring line DcL.

FIG. 18 is a graph showing a result of confirming a light leakage profile in the first long slit s1A and the first short slit s1B.

FIG. 19 is a diagram illustrating a state in which the first short slit s1B overlaps the discharge wiring line DcL and a first light blocking portion 18a of a light blocking layer 18.

FIG. 20 is a graph showing a result of calculating and confirming black luminance, white luminance, and a contrast ratio of the first short slit s1B, obtained by changing a protruding width of the first light blocking portion 18a from a first wiring line edge Le1 of the discharge wiring line DcL.

FIG. 21 is a diagram illustrating a state in which a second short slit s2B overlaps the discharge wiring line DcL and a second light blocking portion 18b of the light blocking layer 18.

FIG. 22 is a diagram illustrating an equivalent circuit of the pixel P to which a pixel division drive technique using a discharge method is applied.

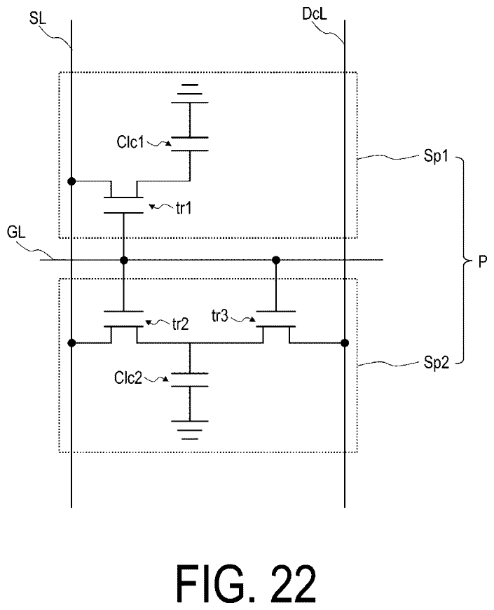

### DESCRIPTION OF EMBODIMENTS

First, main terms used herein will be described.

As used herein, the term “vertically aligned liquid crystal layer” refers to a liquid crystal layer in which liquid crystal molecules are aligned substantially vertically (for example, at an angle of about 85° or greater) with respect to a surface of an alignment film (vertical alignment film). Liquid crystal molecules contained in the vertically aligned liquid crystal layer have negative dielectric anisotropy. By combining the vertically aligned liquid crystal layer with a pair of polarizers arranged in crossed-Nicols so as to face each other with the liquid crystal layer interposed therebetween (that is, arranged so that transmission axes of the polarizers are substantially orthogonal to each other), a normally black mode is displayed.

As used herein, the term “pixel” refers to the smallest unit that represents a specific gray scale in a display, and in a color display, for example, corresponds to a unit that represents the gray scale of each of R, G, and B. A combination of an R pixel, a G pixel, and a B pixel forms one color display pixel. As used herein, a region of a liquid crystal display device (a pixel region) corresponding to a “pixel” in a display is also referred to as a “pixel”.

The term “pretilt direction” refers to an alignment direction of liquid crystal molecules defined by an alignment film, and indicates an azimuth angle direction in a display surface. In this case, an angle formed between the liquid crystal molecules and a surface of the alignment film is referred to as a “pretilt angle”. An alignment treatment applied to the alignment film (a treatment to which the alignment film is subjected and by which an ability to define a pretilt direction in a predetermined direction is realized) is preferably performed by a photo-alignment treatment, as described later.

A four-domain structure can be formed by changing the combination of the pretilt directions by a pair of alignment films facing each other with the liquid crystal layer interposed therebetween. When a pixel (pixel region) is divided into four, the pixel has four liquid crystal domains.

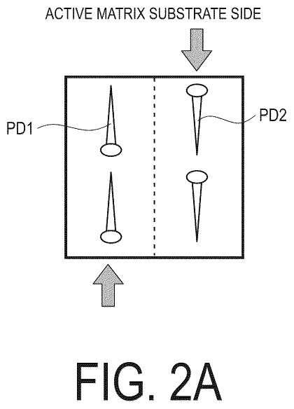

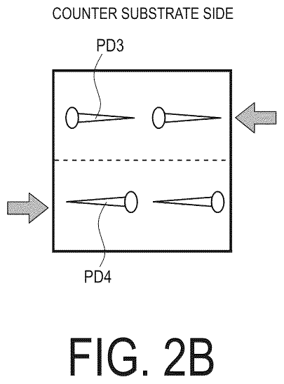

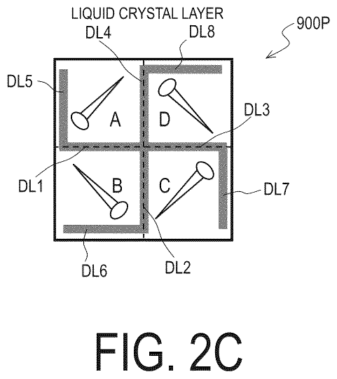

Each liquid crystal domain is characterized by a tilt direction (also referred to as a “reference alignment direction”) of liquid crystal molecules in the vicinity of a center in a layer plane and in a thickness direction of the liquid crystal layer when a voltage is applied to the liquid crystal layer. This tilt direction (reference alignment direction) has a dominant effect on the viewing angle dependence of each domain. When considering a vector of a tilted liquid crystal molecule directed from an end portion thereof closer to a substrate on a back face side toward an end portion thereof farther from the substrate on the back face side (that is, an end portion closer to a substrate on a front face side) (a vector directed from a tip toward a head portion of a pin illustrated in FIG. 2A and the like, which will be described later), the tilt direction is a direction indicated by a component of this vector in a substrate plane (projection on the substrate plane), and the tilt direction is an azimuth angle direction. An azimuth angle direction is measured with reference to a horizontal direction in the display surface and by using a counterclockwise rotation as a positive rotation (when using the example of a clock face as the display surface, a three o'clock direction is defined as an azimuth angle of 0°, and a counterclockwise rotation is defined as a positive rotation). By setting the tilt directions in the four liquid crystal domains so that the angle between any two of the four tilt directions is substantially equal to an integer multiple of 90° (for example, the 10:30 direction, 7:30 direction, 4:30 direction, and 1:30 direction), the viewing angle characteristics are averaged, and thus, a good display can be obtained. In order to obtain uniform viewing angle characteristics, it is preferable that the four liquid crystal domains have substantially equal areas in the pixel region.

A vertically aligned liquid crystal layer described as an example in the following embodiments contains liquid crystal molecules having negative dielectric anisotropy (a nematic liquid crystal material having negative dielectric anisotropy). A pretilt direction defined by one alignment film and a pretilt direction defined by another alignment film differ from each other by about 90°. These two pretilt directions define a tilt direction of a liquid crystal domain (a reference alignment direction). When a voltage is applied to the liquid crystal layer, the liquid crystal molecules in the vicinity of the alignment film shift to a twist alignment according to an alignment regulating force of the alignment film. A chiral agent may not be added to the liquid crystal layer, or a chiral agent may be added as necessary. Thus, a VA mode in which a pair of vertical alignment films provided so that the pretilt directions (alignment treatment directions) are orthogonal to each other are used, and thus, the liquid crystal molecules shift to a twist alignment, may be referred to as a vertical alignment twisted nematic (VATN) mode. In the VATN mode, it is preferable that pretilt angles defined by each alignment film in the pair of alignment films are substantially equal to each other.

In order to enable mass production, a photo-alignment treatment is preferable as the alignment treatment for the alignment films. The photo-alignment treatment can be performed in a non-contact manner. Therefore, no static electricity is generated from friction, as in a rubbing treatment, and thus, it is possible to prevent the yield from decreasing. Furthermore, by using a photo-alignment film containing a photosensitive group, variations in the pretilt angles can be suppressed.

Next, an alignment division structure in a 4D-RTN mode will be described.

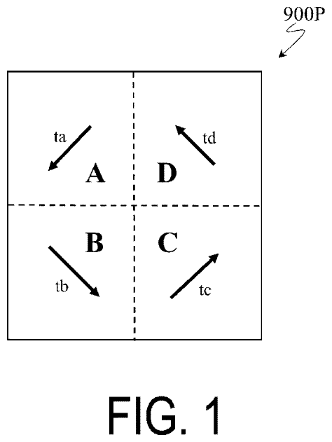

FIG. 1 illustrates an alignment division structure of a pixel 900P in a typical liquid crystal display device using a 4D-RTN mode. When a voltage is applied to the liquid crystal layer, four liquid crystal domains A, B, C, and D are formed in the pixel 900P, as illustrated in FIG. 1. The four liquid crystal domains A, B, C, and D are arranged in a matrix shape having two rows and two columns.

Azimuthal directions of directors ta, tb, tc, and td in the liquid crystal domains A, B, C, and D are four azimuthal directions in which an angle between any two azimuthal directions is substantially equivalent to an integer multiple of 90°. Each of the directors ta, tb, tc, and td is representative of the alignment direction of the liquid crystal molecules contained in each of the liquid crystal domains. In the 4D-RTN mode, each of the directors ta, tb, tc, and td is the tilt direction of the liquid crystal molecules in the vicinity of the center in a layer plane and in a thickness direction of the liquid crystal layer when a voltage is applied to the liquid crystal layer (that is, in the vicinity of the center when the liquid crystal domain is viewed from a direction normal to a display surface and when the liquid crystal domain is viewed in a cross section along the direction normal to the display surface). Each liquid crystal domain is characterized by an azimuthal direction of the director (the above-described tilt direction). The azimuthal direction of the director has a dominant effect on the viewing angle dependence of each domain.

Here, a pair of polarizers facing each other with the liquid crystal layer interposed therebetween are arranged so that transmission axes (polarization axes) thereof are orthogonal to each other. More specifically, the pair of polarizers are arranged so that the transmission axis of one polarizer is parallel to the horizontal direction of the display surface (3 o'clock direction and 9 o'clock direction) and the transmission axis of the other polarizer is parallel to the vertical direction of the display surface (12 o'clock direction and 6 o'clock direction).

When the azimuth angle in the horizontal direction (3 o'clock direction) on the display surface is defined as 0°, an azimuthal direction of the director ta in the liquid crystal domain A is substantially a 225° direction, an azimuthal direction of the director tb in the liquid crystal domain B is substantially a 315° direction, an azimuthal direction of the director tc in the liquid crystal domain C is substantially a 45° direction, and an azimuthal direction of the director td in the liquid crystal domain D is substantially a 135° direction. That is, the liquid crystal domains A, B, C, and D are arranged so that the azimuthal directions of the directors therein differ by about 90° between adjacent the liquid crystal domains.

Referring to FIGS. 2A, 2B, and 2C, an alignment division method of obtaining an alignment division structure of the pixel 900P illustrated in FIG. 1 will be described. FIG. 2A illustrates pretilt directions PD1 and PD2 defined by an alignment film provided in an active matrix substrate. FIG. 2B illustrates pretilt directions PD3 and PD4 defined by an alignment film provided in a counter substrate. FIG. 2C illustrates tilt directions (directors) when a voltage is applied to the liquid crystal layer after the active matrix substrate and the counter substrate are bonded together. FIGS. 2A, 2B, and 2C illustrate the active matrix substrate, the counter substrate, and the liquid crystal layer, as viewed by a viewer. Thus, in FIG. 2A, the alignment film is positioned on a front side of the paper surface with respect to the substrate, and in FIG. 2B, the alignment film is positioned on a back side of the paper surface with respect to the substrate. Each of the pretilt directions and the tilt directions is schematically illustrated in a shape of a pin. A head portion of the pin (an end portion having a larger area) represents an end portion on the front face side (side of a viewer) of a liquid crystal molecule, and a tip of the pin (an end portion having a smaller area) represents an end portion of the back face side of the liquid crystal molecule.

A region on the side of the active matrix substrate (a region corresponding to one pixel 900P) is divided into two regions, that is, left and right regions, as illustrated in FIG. 2A. An alignment treatment is performed so that the alignment films (vertical alignment films) of each of the regions (a left region and a right region) define the pretilt directions PD1 and PD2 that are antiparallel to each other. Here, a photo-alignment treatment is performed by obliquely emitting ultraviolet rays (for example, linearly polarized ultraviolet rays) from directions indicated by arrows.

On the other hand, a region on the side of the counter substrate (a region corresponding to one pixel region 900P) is divided into two regions, that is, upper and lower regions, as illustrated in FIG. 2B. An alignment treatment is performed so that the alignment films (vertical alignment films) of each of the regions (the upper region and the lower region) define the pretilt directions PD3 and PD4 that are antiparallel to each other. Here, a photo-alignment treatment is performed by obliquely emitting ultraviolet rays (for example, linearly polarized ultraviolet rays) from directions indicated by arrows.

By bonding the active matrix substrate and the counter substrate that have been subjected to the alignment treatments as illustrated in FIGS. 2A and 2B, the pixel 900P in which the alignment is divided can be formed as illustrated in FIG. 2C. As can be understood from FIGS. 2A, 2B, and 2C, in each of the liquid crystal domains A to D, the pretilt direction defined by a photo-alignment film on the side of the active matrix substrate and the pretilt direction defined by the photo-alignment film on the side of the counter substrate are different from each other by about 90°. The tilt direction (reference alignment direction) is defined by these two pretilt directions. As can be understood from FIG. 2C, the tilt direction is defined in a middle direction of the pin corresponding to the two pretilt directions.

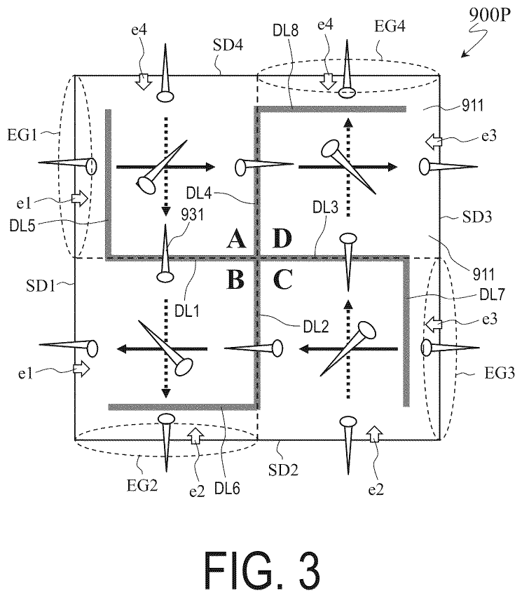

As illustrated in FIG. 2C, dark lines DL1 to DL8 are formed in the pixel 900P having an alignment division structure. Among the dark lines DL1 to DL8, the dark lines DL1 to DL4 are formed at boundaries between adjacent ones of the liquid crystal domains, and the dark lines DL5 to DL8 are formed in the vicinity of edges of the pixel electrode. In the example illustrated in FIG. 2C, the dark lines DL1 to DL8 form a swastika shape in general. The reason why the dark lines DL1 to DL8 are formed will be described below with reference to FIG. 3. FIG. 3 is a plan view schematically illustrating an alignment state of liquid crystal molecules 931 in the pixel 900P.

First, the reason why the dark lines DL1 to DL4 are formed will be described.

When a voltage is applied between a pixel electrode 911 and a counter electrode, a vertical electrical field is generated in the liquid crystal layer, and the liquid crystal molecules 931 in the liquid crystal layer are aligned in a direction orthogonal to the electrical field. That is, the liquid crystal molecules 931 tilt so as to be parallel to the substrate plane. At this time, the azimuthal directions of the directors of the liquid crystal molecules 931 in each of the liquid crystal domains are defined by the pretilt directions defined by the alignment film on the side of the active matrix substrate (indicated by dotted arrows in FIG. 3) and the pretilt directions defined by the alignment film on the side of the counter substrate (indicated by solid arrows in FIG. 3). Specifically, the azimuthal directions of the directors in the liquid crystal domains A, B, C, and D are respectively substantially a 225° direction, substantially a 315° direction, substantially a 45° direction, and substantially a 135° direction.

In the vicinity of the boundary between adjacent ones of the liquid crystal domains, the alignment directions of the liquid crystal molecules 931 change continuously (by the properties of the liquid crystal as a continuous elastic body). Thus, for example, at the boundary between the liquid crystal domain A and the liquid crystal domain B, the liquid crystal molecules 931 are aligned substantially in a 270° direction. Similarly, at the boundary between the liquid crystal domain B and the liquid crystal domain C, the boundary between the liquid crystal domain C and the liquid crystal domain D, and the boundary between the liquid crystal domain D and the liquid crystal domain A, the liquid crystal molecules 931 are respectively aligned in substantially a 0° direction, substantially a 90° direction, and substantially a 180° direction. The 0° direction, the 90° direction, the 180° direction, and the 270° direction are directions parallel to or orthogonal to the transmission axes of the pair of polarizers. The dark lines DL1 to DL4 are formed at the boundaries between adjacent ones of the liquid crystal domains.

Next, the reason why the dark lines DL5 to DL8 are formed will be described.

When an edge of the pixel electrode 911 adjacent to a liquid crystal domain includes a portion where an azimuth angle direction being orthogonal to the edge and being directed toward the inside of the pixel electrode 911 forms an angle of greater than 90° with the tilt direction (reference alignment direction) in the liquid crystal domain (hereinafter referred to as an “edge portion”), a dark line is formed parallel to the edge portion further inside than the edge portion.

As illustrated in FIG. 3, the pixel electrode 911 has four edges (sides) SD1, SD2, SD3, and SD4. Upon application of a voltage, oblique electrical fields are generated at the edges SD1, SD2, SD3, and SD4. The oblique electrical fields exert alignment regulating forces that are orthogonal to respective ones of the edges and have components in directions toward the inside of the pixel electrode 911 (azimuth angle directions). In FIG. 3, the azimuth angle directions each being orthogonal to a corresponding one of the four edges SD1, SD2, SD3, and SD4 and being directed toward the inside of the pixel electrode 911 are indicated by arrows e1, e2, e3, and e4.

The four liquid crystal domains A, B, C, and D are each adjacent to two of the four edges SD1, SD2, SD3, and SD4 of the pixel electrode 911, and are subjected to the alignment regulating forces from an oblique electrical field generated at each of the edges when a voltage is applied.

At an edge portion EG1 among the edges of the pixel electrode 911 to which the liquid crystal domain A is adjacent (an upper half of the edge SD1 on the left side), the azimuth angle direction e1 being orthogonal to the edge portion EG1 and being directed toward the inside of the pixel electrode 911 forms an angle of greater than 90° (specifically, about) 135° with the tilt direction ta in the liquid crystal domain A. As a result, in the liquid crystal domain A, the dark line DL5 is formed parallel to the edge portion EG1 when a voltage is applied.

Similarly, at an edge portion EG2 among the edges of the pixel electrode 911 to which the liquid crystal domain B is adjacent (a left half of the edge SD2 on a lower side), the azimuth angle direction e2 being orthogonal to the edge portion EG2 and being directed toward the inside of the pixel electrode 911 forms an angle of greater than 90° (specifically, about) 135° with the tilt direction tb in the liquid crystal domain B. As a result, in the liquid crystal domain B, the dark line DL6 is formed parallel to the edge portion EG2 when a voltage is applied.

Similarly, at an edge portion EG3 among the edges of the pixel electrode 911 to which the liquid crystal domain C is adjacent (a lower half of the edge SD3 on the right side), the azimuth angle direction e3 being orthogonal to the edge portion EG3 and being directed toward the inside of the pixel electrode 911 forms an angle of greater than 90° (specifically, about) 135° with the tilt direction tc in the liquid crystal domain C. As a result, in the liquid crystal domain C, the dark line DL7 is formed parallel to the edge portion EG3 when a voltage is applied.

Similarly, at an edge portion EG4 among the edges of the pixel electrode 911 to which the liquid crystal domain D is adjacent (a right half of the edge SD4 on the upper side), the azimuth angle direction e4 being orthogonal to the edge portion EG4 and being directed toward the inside of the pixel electrode 911 forms an angle of greater than 90° (specifically, about) 135° with the tilt direction td in the liquid crystal domain D. As a result, in the liquid crystal domain D, the dark line DL8 is formed parallel to the edge portion EG4 when a voltage is applied.

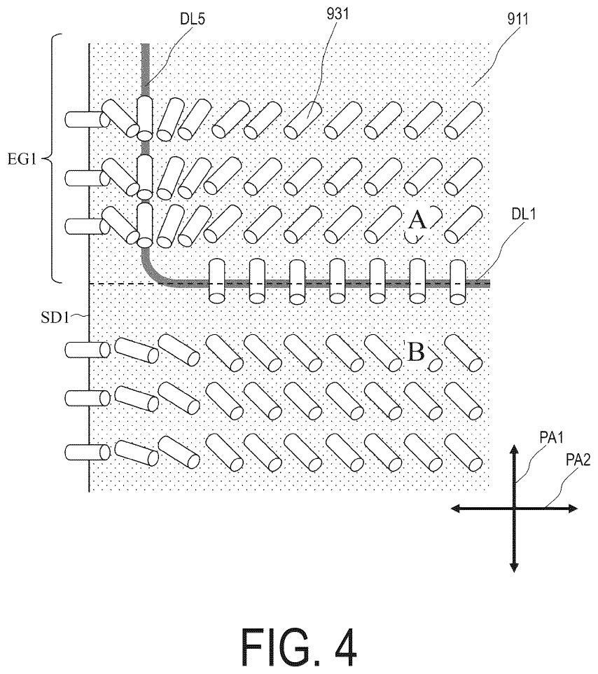

FIG. 4 illustrates an alignment state of the liquid crystal molecules 931 in the vicinity of the edge SD1. As illustrated in FIG. 4, in the vicinity of the edge portion EG1 of the edge SD1, the alignment continuously changes from a direction orthogonal to the edge SD1 (substantially a 0° direction) to the tilt direction ta in the liquid crystal domain A (substantially a 225° direction). As a result, there is a region in which the liquid crystal molecules 931 are aligned in a direction substantially parallel to the transmission axis PA1 and substantially orthogonal to the transmission axis PA2 of the pair of polarizers (substantially a 270° direction). This region is the dark line DL5.

In contrast, in the vicinity of a portion of the edge SD1 other than the edge portion EG1, the alignment changes continuously from the direction orthogonal to the edge SD1 (substantially a 0° direction) to the tilt direction tb (substantially a 315° direction) in the liquid crystal domain B. However, there is no region in which the liquid crystal molecules 931 are aligned in a direction substantially parallel to the transmission axis PA1 and substantially orthogonal to the transmission axis PA2 of the polarizers. Thus, no dark line is formed.

For a similar reason, in the other edges SD2, SD3, and SD4, the dark lines DL6, DL7, and DL8 are formed in the vicinity of the edge portions EG2, EG3, and EG4. However, no dark line is formed in the vicinity of portions other than the edge portions EG2, EG3, and EG4.

The dark lines that are formed by the mechanism described above cause a decrease in the transmittance of a pixel.

Embodiments of the disclosure will be described below with reference to the drawings. Note that the disclosure is not limited to the embodiments described below.

### First Embodiment

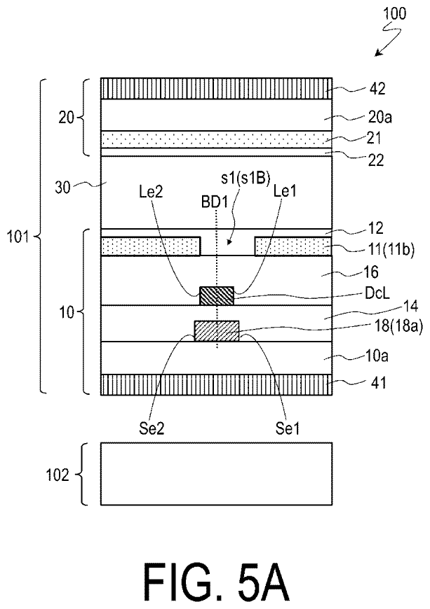

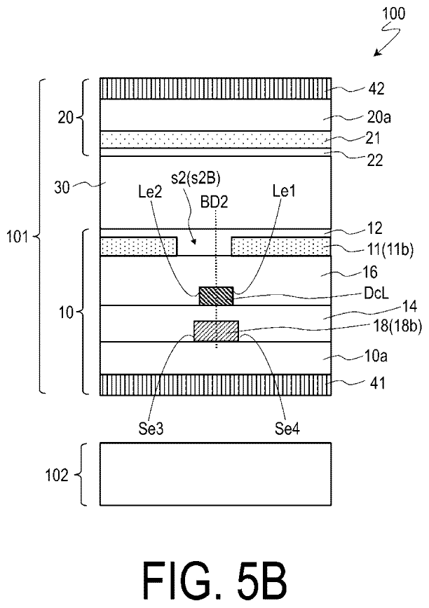

A liquid crystal display device 100 according to the present embodiment will be described with reference to FIGS. 5A and 5B. FIGS. 5A and 5B each illustrate a cross-sectional view schematically illustrating the liquid crystal display device 100.

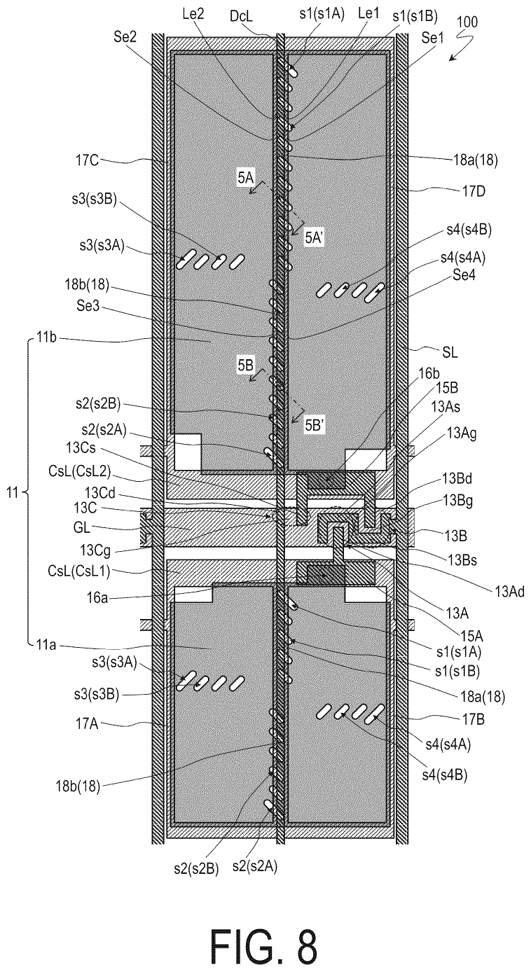

As illustrated in FIGS. 5A and 5B, the liquid crystal display device 100 includes a liquid crystal display panel 101 and a backlight (illumination device) 102. The liquid crystal display panel 101 includes an active matrix substrate (a first substrate) 10 and a counter substrate (a second substrate) 20 facing each other, and a vertically aligned liquid crystal layer 30 and provided between the active matrix substrate 10 and the counter substrate 20. The backlight 102 is arranged on a back face side (a side opposite to the viewer) of the liquid crystal display panel 101. The liquid crystal display device 100 includes a plurality of pixels arrayed in a matrix shape including a plurality of pixel rows and a plurality of pixel columns. FIGS. 5A and 5B each illustrate a cross section corresponding to a part of one pixel (a cross section taken along a line 5A-5A′ in FIG. 8 and a cross section taken along a line 5B-5B′, which will be described later).

The active matrix substrate 10 includes a pixel electrode 11 provided for each of a plurality of pixels, and a first alignment film 12 provided between the pixel electrode 11 and the liquid crystal layer 30 (that is, an outermost surface of the active matrix substrate 10 on the side of the liquid crystal layer 30). The pixel electrode 11 and the first alignment film 12 are supported by the substrate 10a. The substrate 10a is transparent and has insulating properties. The substrate 10a is, for example, a glass substrate or a plastic substrate. The pixel electrode 11 is formed of a transparent conductive material (for example, indium tin oxide (ITO)). The configuration of the active matrix substrate 10 will be described in more detail later.

The counter substrate 20 includes a counter electrode 21 facing the pixel electrode 11, and a second alignment film 22 provided between the counter electrode 21 and the liquid crystal layer 30 (that is, on an outermost surface of the counter substrate 20 on the side of the liquid crystal layer 30). The counter electrode 21 and the second alignment film 22 are supported by the substrate 20a. The substrate 20a is transparent and has insulating properties. The substrate 20a is, for example, a glass substrate or a plastic substrate. The counter electrode 21 is formed of a transparent conductive material (for example, ITO). The counter electrode 21 may be a continuous conductive film formed over the entire display region. That is, the counter electrode 21 may be a common electrode to which a common potential is applied in all of the pixels.

Note that, in addition to the above-described counter electrode 21 and the second alignment film 22, the counter substrate 20 includes a color filter layer and a black matrix, which are not illustrated in the drawings. The color filter layer typically includes a red color filter, a green color filter, and a blue color filter.

The first alignment film 12 and the second alignment film 22 have alignment regulating forces that align the liquid crystal molecules substantially vertically to the surfaces of the first alignment film 12 and the second alignment film 22. In the present embodiment, the first alignment film 12 and the second alignment film 22 are subjected to a photo-alignment treatment. That is, both the first alignment film 12 and the second alignment film 22 are photo-alignment films.

The liquid crystal display device 100 further includes a pair of polarizers 41 and 42 that face each other with the liquid crystal layer 30 interposed therebetween. The pair of polarizers 41 and 42 are arranged so that transmission axes thereof are substantially orthogonal to each other (that is, in crossed-Nicols).

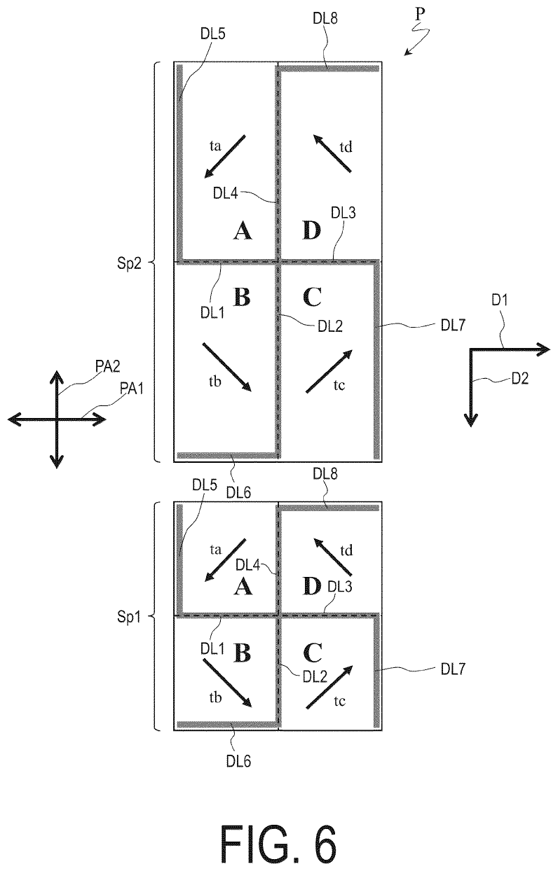

FIG. 6 is a diagram illustrating an alignment division structure of one pixel P in the liquid crystal display device 100. FIG. 6 illustrates a row direction D1 in which pixel rows extend and a column direction D2 in which pixel columns extend. In the example illustrated in FIG. 6, the pixel P substantially has a rectangular shape in which a longitudinal direction parallel to the column direction D2 and a traverse direction parallel to the row direction D1 are defined.

As illustrated in FIG. 6, each pixel P of the liquid crystal display device 100 includes a first subpixel Sp1 and a second subpixel Sp2. Different voltages may be applied to the liquid crystal layer 30 of the first subpixel Sp1 and the liquid crystal layer 30 of the second subpixel Sp2. That is, pixel division drive is performed in the liquid crystal display device 100. Here, a relatively high voltage may be applied to the liquid crystal layer 30 of the first subpixel Sp1, and a relatively low voltage may be applied to the liquid crystal layer 30 of the second subpixel Sp2. Accordingly, the first subpixel Sp1 is a “bright subpixel” that exhibits higher luminance than the second subpixel Sp2 at least at a certain gray scale, and the second subpixel Sp2 is a “dark subpixel” that exhibits lower luminance than the first subpixel Sp1.

When a voltage is applied between the pixel electrode 11 and the counter electrode 21, the four liquid crystal domains A, B, C, and D are formed in the liquid crystal layer 30 in each of the bright subpixel (the first subpixel) Sp1 and the dark subpixel (the second subpixel) Sp2, as illustrated in FIG. 6. The four directors (reference alignment directions defined by the first alignment film 12 and the second alignment film 22) ta, tb, tc, and td, which represent the alignment directions of the liquid crystal molecules contained in each of the liquid crystal domains A, B, C, and D, have azimuthal directions different from each other.

When the azimuth angle in the horizontal direction (3 o'clock direction) on the display surface is defined as 0°, an azimuthal direction of the director ta in the liquid crystal domain A is substantially a 225° direction, an azimuthal direction of the director tb in the liquid crystal domain B is substantially a 315° direction, an azimuthal direction of the director tc in the liquid crystal domain C is substantially a 45° direction, and an azimuthal direction of the director td in the liquid crystal domain D is substantially a 135° direction. That is, the difference between any two azimuthal directions among the azimuthal directions of the four directors ta, tb, tc, and td in the liquid crystal domains A, B, C, and D is substantially equal to an integer multiple of 90°. Note that, herein, substantially a 45° direction, substantially a 135° direction, substantially a 225° direction, and substantially a 315° direction refer to a “40° to 50° direction”, a “130° to 140° direction”, a “220° to 230° direction”, and a “310° to 320° direction”, respectively.

One of the transmission axes (polarization axes) PA1 and PA2 of the pair of polarizers 41 and 42 is parallel to the horizontal direction of the display surface, and the other one of the transmission axes PA1 and PA2 is parallel to the vertical direction of the display surface. Accordingly, the transmission axes PA1 and PA2 of the polarizers 41 and 42 form angles of about 45° with the azimuthal directions of the directors ta, tb, tc, and td in the liquid crystal domains A, B, C, and D.

The four liquid crystal domains A, B, C, and D in each of the first subpixel Sp1 and the second subpixel Sp2 are each adjacent to other liquid crystal domains, and arranged in a matrix shape having two rows and two columns. In the example illustrated in FIG. 6, the liquid crystal domains A, B, C, and D are arranged in the order from the upper left, lower left, lower right, and upper right (that is, counterclockwise from the upper left). Therefore, in two liquid crystal domains adjacent to each other in the row direction or the column direction among the liquid crystal domains A, B, C, and D, the azimuthal directions of the directors differ from each other by about 90°. In two liquid crystal domains adjacent to each other in an oblique direction inclined with respect to the row direction and the column direction, the azimuthal directions of the directors differ from each other by about 180°. Note that, hereinafter, for convenience of description, the liquid crystal domains D, B, A, and C may be respectively referred to as a “first liquid crystal domain”, a “second liquid crystal domain”, a “third liquid crystal domain”, and a “fourth liquid crystal domain”.

An alignment division method used for obtaining an alignment division structure of the pixel P illustrated in FIG. 6 is easily understood from the alignment division method described for the alignment division structure of the pixel 900P illustrated in FIG. 1, and thus, the description thereof is omitted here. Further, the dark lines DL1 to DL8 are formed in each of the first subpixel Sp1 and the second subpixel Sp2 of the pixel P for a similar reason as described for the pixel 900P. The dark lines DL1 to DL8 form a swastika shape in general.

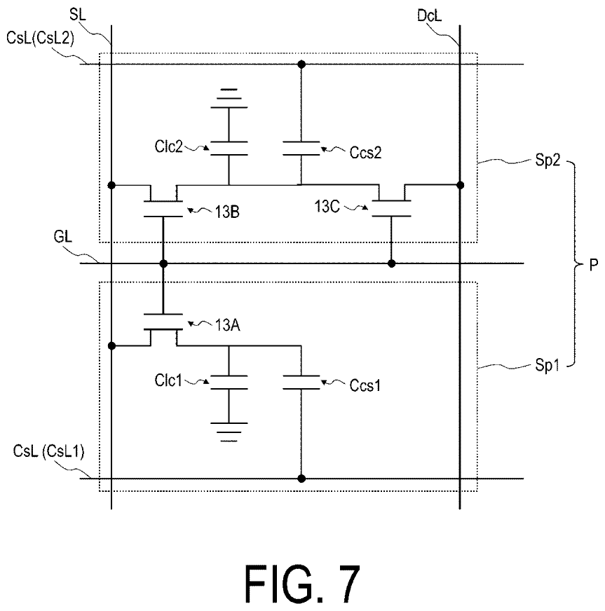

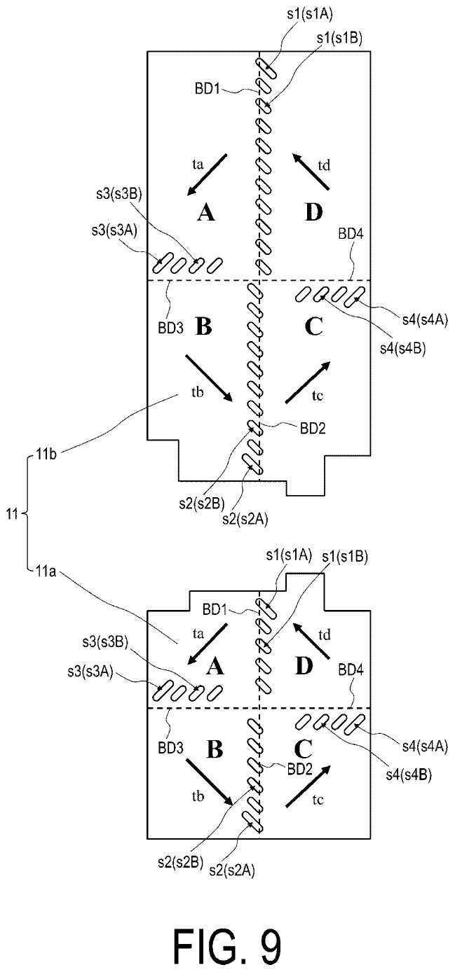

Here, a configuration of the liquid crystal display device 100 will be further described in more detail with reference to FIGS. 7, 8, and 9. FIG. 7 is a diagram illustrating an equivalent circuit of the pixel P. FIG. 8 is a plan view schematically illustrating the liquid crystal display device 100 and illustrates a region corresponding to one pixel P. FIG. 9 is a plan view schematically illustrating the pixel electrode 11 in the liquid crystal display device 100 and also illustrates a domain arrangement.

As illustrated in FIGS. 7, 8, and 9, the pixel electrode 11 includes a first subpixel electrode 11a and a second subpixel electrode 11b. The first subpixel electrode 11a is provided in the first subpixel Sp1. The second subpixel electrode 11b is provided in the second subpixel Sp2.

The first subpixel electrode 11a, the counter electrode 21 facing the first subpixel electrode 11a, and the liquid crystal layer 30 located between the first subpixel electrode 11a and the counter electrode 21 constitute a first liquid crystal capacitor Clc1. The second subpixel electrode 11b, the counter electrode 21 facing the second subpixel electrode 11b, and the liquid crystal layer 30 located between the second subpixel electrode 11b and the counter electrode 21 constitute a second liquid crystal capacitor Clc2. A first auxiliary capacitor Ccs1 is electrically connected in parallel to the first liquid crystal capacitor Clc1. A second auxiliary capacitor Ccs2 is electrically connected in parallel to the second liquid crystal capacitor Clc2.

Each of the first subpixel electrode 11a and the second subpixel electrode 11b includes at least one first slit s1 (here, a plurality of first slits s1), at least one second slit s2 (here, a plurality of second slits s2), at least one third slit s3 (here, a plurality of third slits s3), and at least one fourth slit s4 (here, a plurality of fourth slits s4).

The plurality of first slits s1 extend substantially parallel to the director td of the liquid crystal domain D (the first liquid crystal domain). The plurality of first slits s1 are located in the vicinity of a first boundary BD1, which is a boundary between the liquid crystal domain D and the liquid crystal domain A (the third liquid crystal domain). Here, the plurality of first slits s1 include a first long slit s1A and at least one first short slit s1B (a plurality of first short slits s1B in the example in the drawings) shorter than the first long slit s1A. Among the plurality of first slits s1, the first long slit s1A is closest to an end of the electrode.

The plurality of second slits s2 extend substantially parallel to the director tb of the liquid crystal domain B (the second liquid crystal domain). The plurality of second slits s2 are located in the vicinity of a second boundary BD2, which is a boundary between the liquid crystal domain B and the liquid crystal domain C (the fourth liquid crystal domain). Here, the plurality of second slits s2 include a second long slit s2A and at least one second short slit s2B (a plurality of second short slits s2B in the example in the drawings) shorter than the second long slit s2A. Among the plurality of second slits s2, the second long slit s2A is closest to an end of the electrode.

The plurality of third slits s3 extend substantially parallel to the director ta of the liquid crystal domain A (the third liquid crystal domain). The plurality of third slits s3 are located in the vicinity of a third boundary BD3, which is a boundary between the liquid crystal domain A and the liquid crystal domain B (the second liquid crystal domain). Here, the plurality of third slits s3 include a third long slit s3A and at least one third short slit s3B (a plurality of third short slits s3B in the example in the drawings) shorter than the third long slit s3A. Among the plurality of third slits s3, the third long slit s3A is closest to an end of the electrode.

The plurality of fourth slits s4 extend substantially parallel to the director tc of the liquid crystal domain C (the fourth liquid crystal domain). The plurality of fourth slits s4 are located in the vicinity of a fourth boundary BD4, which is a boundary between the liquid crystal domain C and the liquid crystal domain D (the first liquid crystal domain). Here, the plurality of fourth slits s4 include a fourth long slit s4A and at least one fourth short slit s4B (a plurality of fourth short slits s4B in the example in the drawings) shorter than the fourth long slit s4A. Among the plurality of fourth slits s4, the fourth long slit s4A is closest to an end of the electrode.

In the following description, the first slit s1, the second slit s2, the third slit s3, and the fourth slit s4 described above may be collectively referred to simply as “slits”.

In addition to the pixel electrode 11 and the first alignment film 12 described above, the active matrix substrate 10 includes a plurality of gate wiring lines GL, a plurality of source wiring lines SL, a plurality of auxiliary capacitor wiring lines CsL, and a plurality of discharge wiring lines DcL.

Each of the gate wiring lines GL extends in the row direction and supplies a gate signal to a corresponding pixel row among the plurality of pixel rows. Each of the source wiring lines SL extends in the column direction and supplies a source signal to a corresponding pixel column among the plurality of pixel columns.

Each of the auxiliary capacitor wiring lines CsL extends in the row direction. For example, a potential applied to the auxiliary capacitor wiring line CsL is the same as a potential (common potential) applied to the counter electrode 21. In the example illustrated in the drawings, two auxiliary capacitor wiring lines CsL (a first auxiliary capacitor wiring line CsL1 and a second auxiliary capacitor wiring line CsL2) are arranged in one pixel row. Each of the discharge wiring lines DcL extends in the column direction. The potential applied to the discharge wiring line DcL is a constant potential, and is different from the potential applied to the counter electrode 21.

The active matrix substrate 10 includes a first TFT 13A, a second TFT 13B, and a third TFT 13C in each pixel P. The first TFT 13A, the second TFT 13B, and the third TFT 13C respectively include gate electrodes 13Ag, 13Bg, and 13Cg, a gate insulating layer 14, a semiconductor layer (not illustrated), source electrodes 13As, 13Bs, and 13Cs, and drain electrodes 13Ad, 13Bd, and 13Cd.

The gate electrode 13Ag of the first TFT 13A is electrically connected to the gate wiring line GL. In the example illustrated in the drawings, a part of the gate wiring line GL (a part overlapping a semiconductor layer of the first TFT 13A) functions as the gate electrode 13Ag. The source electrode 13As of the first TFT 13A is electrically connected to the source wiring line SL. In the example illustrated in the drawings, the source electrode 13As extends from the source electrode 13Bs of the second TFT 13B and is electrically connected to the source wiring line SL via the source electrode 13Bs of the second TFT 13B. The drain electrode 13Ad of the first TFT 13A is electrically connected to the first subpixel electrode 11a. More specifically, the drain electrode 13Ad is electrically connected to the first subpixel electrode 11a via a first auxiliary capacitor electrode 15A that is integrally formed with the drain electrode 13Ad. The first auxiliary capacitor Ccs1 is constituted by the first auxiliary capacitor electrode 15A, a part of the first auxiliary capacitor wiring line CsL1 overlapping the first auxiliary capacitor electrode 15A, and the gate insulating layer 14 located therebetween. Therefore, the first TFT 13A is electrically connected to the gate wiring line GL, the source wiring line SL, and the first subpixel electrode 11a.

The gate electrode 13Bg of the second TFT 13B is electrically connected to the gate wiring line GL. In the example illustrated in the drawings, a part of the gate wiring line GL (a part overlapping a semiconductor layer of the second TFT 13B) functions as the gate electrode 13Bg. The source electrode 13Bs of the second TFT 13B is electrically connected to the source wiring line SL. In the example illustrated in the drawings, the source electrode 13Bs extends from the source wiring line SL. The drain electrode 13Bd of the second TFT 13B is electrically connected to the second subpixel electrode 11b. More specifically, the drain electrode 13Bd is electrically connected to the second subpixel electrode 11b via a second auxiliary capacitor electrode 15B that is integrally formed with the drain electrode 13Bd. The second auxiliary capacitor Ccs2 is constituted by the second auxiliary capacitor electrode 15B, a part of the second auxiliary capacitor wiring line CsL2 overlapping the second auxiliary capacitor electrode 15B, and the gate insulating layer 14 located therebetween. Therefore, the second TFT 13B is electrically connected to the gate wiring line GL, the source wiring line SL, and the second subpixel electrode 11b.

The gate electrode 13Cg of the third TFT 13C is electrically connected to the gate wiring line GL. In the example illustrated in the drawings, a part of the gate wiring line GL (a part overlapping a semiconductor layer of the third TFT 13C) functions as the gate electrode 13Cg. The source electrode 13Cs of the third TFT 13C is electrically connected to the drain electrode 13Bd of the second TFT 13B and the second subpixel electrode 11b. In the example illustrated in the drawings, the source electrode 13Cs extends from the second auxiliary capacitor electrode 15B and is electrically connected to the drain electrode 13Bd of the second TFT 13B and the second subpixel electrode 11b via the second auxiliary capacitor electrode 15B. The drain electrode 13Cd of the third TFT 13C is electrically connected to the discharge wiring line DcL. In the example illustrated in the drawings, a part of the discharge wiring line DcL functions as the drain electrode 13Cd of the third TFT 13C.

The first TFT 13A, the second TFT 13B, and the third TFT 13C are covered by an interlayer insulating layer 16. The pixel electrode 11 is provided on the interlayer insulating layer 16. The interlayer insulating layer 16 has a first contact hole 16a formed on the first auxiliary capacitor electrode 15A and a second contact hole 16b formed on the second auxiliary capacitor electrode 15B. The first subpixel electrode 11a is electrically connected to the drain electrode 13Ad of the first TFT 13A via the first contact hole 16a. Similarly, the second subpixel electrode 11b is electrically connected to the drain electrode 13Bd of the second TFT 13B via the second contact hole 16b.

In the liquid crystal display device 100, pixel division drive using a discharge method is performed. When the gate signal supplied by the gate wiring line GL changes from a low level to a high level, the first TFT 13A, the second TFT 13B, and the third TFT 13C are turned on. Thus, the source signal is supplied from the source wiring line SL to the first subpixel electrode 11a and the second subpixel electrode 11b via the first TFT 13A and the second TFT 13B, respectively, and the first liquid crystal capacitor Clc1 and the second liquid crystal capacitor Clc2 are charged. At this time, in the second subpixel Sp2, voltage division is performed in accordance with the ratio between the on-resistance of the second TFT 13B and the on-resistance of the third TFT 13C. Thus, the voltage applied to the second liquid crystal capacitor Clc2 is lower than the voltage applied to the first liquid crystal capacitor Clc1. Therefore, the first subpixel Sp1 can be caused to function as a bright subpixel that is relatively bright, and the second subpixel Sp2 can be caused to function as a dark subpixel that is relatively dark.

In the example illustrated in the drawings, a pair of capacitance reducing electrodes 17A and 17B extend from the first auxiliary capacitor wiring line CsL1. The pair of capacitance reducing electrodes 17A and 17B extend along the column direction, and overlap with an edge of the first subpixel electrode 11a parallel to the column direction in a plan view. In the example illustrated in the drawings, a pair of capacitance reducing electrodes 17C and 17D extend from the second auxiliary capacitor wiring line CsL2. The pair of capacitance reducing electrodes 17C and 17D extend along the column direction, and overlap with an edge of the second subpixel electrode 11b parallel to the column direction in a plan view. The above-described capacitance reducing electrodes 17A, 17B, 17C, and 17D are provided, and thus, an electrical field between the source wiring line SL and the pixel electrode 11 can be blocked. Therefore, parasitic capacitance generated between the source wiring line SL and the pixel electrode 11 can be reduced.

In the present embodiment, the discharge wiring line DcL is arranged so as to overlap the first boundary BD1 and the second boundary BD2 in a plan view, as illustrated in FIGS. 5A, 5B, and 8. In the example illustrated in the drawings, the discharge wiring line DcL is formed in the same layer as the source wiring line SL (that is, it is formed from the same source metal as the source wiring line SL), and is covered by the interlayer insulating layer 16.

The plurality of slits included in the pixel electrode 11 include a slit that at least partially overlaps the discharge wiring line DcL in a plan view. In the example illustrated in the drawings, the first slit s1 and the second slit s2 partially overlap the discharge wiring line DcL in a plan view.

In the present embodiment, the active matrix substrate 10 further includes a light blocking layer 18 arranged in each of the first subpixel Sp1 and the second subpixel Sp2, as illustrated in FIGS. 5A, 5B, and 8. The light blocking layer 18 includes a light blocking portion 18a arranged so as to at least partially overlap the first slit s1 in a plan view. The light blocking layer 18 includes a further light blocking portion 18b arranged so as to at least partially overlap the second slits s2 in a plan view. Hereinafter, the light blocking portion 18a is referred to as a “first light blocking portion”, and the further light blocking portion 18b is referred to as a “second light blocking portion”.

Each of the first slits s1 includes a portion overlapping both the first light blocking portion 18a and the discharge wiring line DcL in a plan view, and a portion overlapping the first light blocking portion 18a and not overlapping the discharge wiring line DcL in a plan view. Similarly, each of the second slits s2 includes a portion overlapping both the second light blocking portion 18b and the discharge wiring line DcL in a plan view, and a portion overlapping the second light blocking portion 18b and not overlapping the discharge wiring line DcL in a plan view.

The light blocking layer 18 is formed of a conductive material and a predetermined potential is applied to the light blocking layer 18. Here, the predetermined potential applied to the light blocking layer 18 is the same as the potential applied to the auxiliary capacitor wiring line CsL, and is, for example, the same as the potential (common potential) applied to the counter electrode 21. In the example illustrated in the drawings, the light blocking layer 18 is formed in the same layer as the gate wiring line GL (that is, is formed from the same gate metal as the gate wiring line GL). The light blocking layer 18 of the first subpixel Sp1 extends from the first auxiliary capacitor wiring line CsL1, and substantially extends in the same direction as the direction in which the discharge wiring line DcL extends. The light blocking layer 18 of the second subpixel Sp2 extends from the second auxiliary capacitor wiring line CsL2, and substantially extends in the same direction as the direction in which the discharge wiring line DcL extends.

The discharge wiring line DcL includes a first wiring line edge Le1 and a second wiring line edge Le2 that define the width of the discharge wiring line DcL. When focusing on the positions of the first wiring line edge Le1 and the second wiring line edge Le2 in the row direction, as illustrated in FIG. 5A, the first wiring line edge Le1 is located closer to the liquid crystal domain D (the first liquid crystal domain) than the first boundary BD1, and the second wiring line edge Le2 is located closer to the liquid crystal domain A (the third liquid crystal domain) than the first boundary BD1. That is, the first wiring line edge Le1 is located relatively closer to the liquid crystal domain D, and the second wiring line edge Le2 is located relatively closer to the liquid crystal domain A. As illustrated in FIG. 5B, the first wiring line edge Le1 is located closer to the liquid crystal domain C (the fourth liquid crystal domain) than the second boundary BD2, and the second wiring line edge Le2 is located closer to the liquid crystal domain B (the second liquid crystal domain) than the second boundary BD2. That is, the first wiring line edge Le1 is located relatively closer to the liquid crystal domain C, and the second wiring line edge Le2 is located relatively closer to the liquid crystal domain B.

The first light blocking portion 18a of the light blocking layer 18 includes a first light blocking layer edge Se1 and a second light blocking layer edge Se2 that define the width of the first light blocking portion 18a. When focusing on the positions of the first light blocking layer edge Se1 and the second light blocking layer edge Se2 in the row direction, as illustrated in FIG. 5A, the first light blocking layer edge Se1 is located closer to the liquid crystal domain D (the first liquid crystal domain) than the first boundary BD1, and the second light blocking layer edge Se2 is located closer to the liquid crystal domain A (the third liquid crystal domain) than the first boundary BD1. That is, the first light blocking layer edge Se1 is located relatively closer to the liquid crystal domain D, and the second light blocking layer edge Se2 is located relatively closer to the liquid crystal domain A.

The second light blocking portion 18b of the light blocking layer 18 includes a third light blocking layer edge Se3 and a fourth light blocking layer edge Se4 that define the width of the second light blocking portion 18b. When focusing on the positions of the third light blocking layer edge Se3 and the fourth light blocking layer edge Se4 in the row direction, as illustrated in FIG. 5B, the third light blocking layer edge Se3 is located closer to the liquid crystal domain B (the second liquid crystal domain) than the second boundary BD2, and the fourth light blocking layer edge Se4 is located closer to the liquid crystal domain C (the fourth liquid crystal domain) than the second boundary BD2. That is, the third light blocking layer edge Se3 is located relatively closer to the liquid crystal domain B, and the fourth light blocking layer edge Se4 is located relatively closer to the liquid crystal domain C.

In the example illustrated in the drawings, the first light blocking portion 18a is arranged so that a center of the first light blocking portion 18a in the width direction substantially coincides with a center of the discharge wiring line DcL in the width direction in a plan view, and the first light blocking portion 18a is wider than the discharge wiring line DcL. Therefore, the first wiring line edge Le1 is located between the first boundary BD1 and the first light blocking layer edge Se1, and the second wiring line edge Le2 is located between the first boundary BD1 and the second light blocking layer edge Se2. That is, the first light blocking portion 18a protrudes further outward in the width direction than the discharge wiring line DcL.

In the example illustrated in the drawings, the second light blocking portion 18b is arranged so that a center of the second light blocking portion 18b in the width direction substantially coincides with the center of the discharge wiring line DcL in the width direction in a plan view, and the second light blocking portion 18b is wider than the discharge wiring line DcL. Therefore, the second wiring line edge Le2 is located between the second boundary BD2 and the third light blocking layer edge Se3, and the first wiring line edge Le1 is located between the second boundary BD2 and the fourth light blocking layer edge Se4. That is, the second light blocking portion 18b protrudes further outward in the width direction than the discharge wiring line DcL.

As described above, in the liquid crystal display device 100 of the present embodiment, each of the first subpixel electrode 11a and the second subpixel electrode 11b include the first slit s1, the second slit s2, the third slit s3, and the fourth slit s4.

The first slit s1 extending substantially parallel to the director td of the liquid crystal domain D is provided in the vicinity of the first boundary BD1, and thus, the number of liquid crystal molecules aligned substantially parallel to the director td increases (the existence probability increases) in the vicinity of the first boundary BD1. Therefore, the area of the dark line DL4 decreases.

Similarly, the second slit s2 extending substantially parallel to the director tb of the liquid crystal domain B is provided in the vicinity of the second boundary BD2, and thus, the number of liquid crystal molecules aligned substantially parallel to the director tb increases (the existence probability increases) in the vicinity of the second boundary BD2. Therefore, the area of the dark line DL2 decreases.

Similarly, the third slit s3 extending substantially parallel to the director ta of the liquid crystal domain A is provided in the vicinity of the third boundary BD3, and thus, the number of liquid crystal molecules aligned substantially parallel to the director ta increases (the existence probability increases) in the vicinity of the third boundary BD3. Therefore, the area of the dark line DL1 decreases.

Similarly, the fourth slit s4 extending substantially parallel to the director tc of the liquid crystal domain C is provided in the vicinity of the fourth boundary BD4, and thus, the number of liquid crystal molecules aligned substantially parallel to the director tc increases (the existence probability increases) in the vicinity of the fourth boundary BD4. Therefore, the area of the dark line DL3 decreases.

As described above, the first slit s1, the second slit s2, the third slit s3, and the fourth slit s4 are formed in the vicinity of the domain boundary of the pixel electrode 11, and thus, it is possible to reduce the area of the dark line formed in the vicinity of the domain boundary. The dark line can also be referred to as an alignment defect region, and thus, it is possible to reduce an alignment defect in the alignment defect region.

In the example illustrated in the drawings, the plurality of first slits s1 are arranged so that the first long slit s1A is closest to the end of the electrode. The plurality of second slits s2 are arranged so that the second long slit s2A is closest to the end of the electrode. The plurality of third slits s3 are arranged so that the third long slit s3A is closest to the end of the electrode. The plurality of fourth slits s4 are arranged so that the fourth long slit s4A is closest to the end of the electrode. According to the above-described configuration, the area of the dark line can be more effectively reduced.

Note that the number of each of the first slits s1, the second slits s2, the third slits s3, and the fourth slits s4 is not limited to the example illustrated in the drawings. The widths of the first slit s1, the second slit s2, the third slit s3, and the fourth slit s4 are not particularly limited, but are, for example, from 2 μm to 4 μm. The lengths of the first long slit s1A, the second long slit s2A, the third long slit s3A, and the fourth long slit s4A are not particularly limited, but are, for example, from 10 μm to 18 μm. The lengths of the first short slit s1B, the second short slit s2B, the third short slit s3B, and the fourth short slit s4B are not particularly limited, but are, for example, from 6 μm to 10 μm.

In the liquid crystal display device 100 of the present embodiment, the discharge wiring line DcL is arranged so as to overlap the first boundary BD1 and the second boundary BD2 in a plan view. The first boundary BD1 and the second boundary BD2 are regions in which the dark lines DL4 and DL2 are formed. Thus, by arranging the discharge wiring line DcL so as to overlap the first boundary BD1 and the second boundary BD2, it is possible to suppress a decrease in light utilization efficiency caused by the discharge wiring line DcL (typically formed of a material having a light blocking property such as a metal).

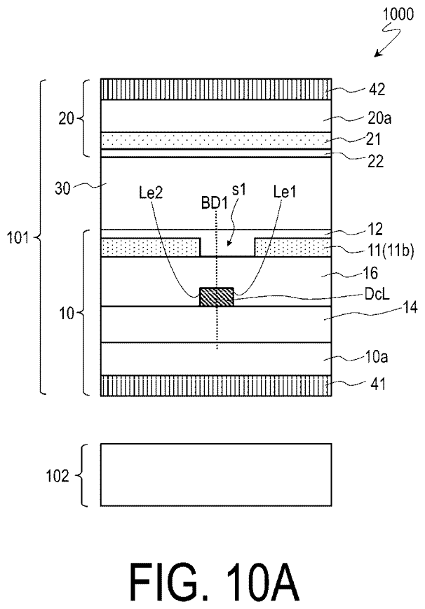

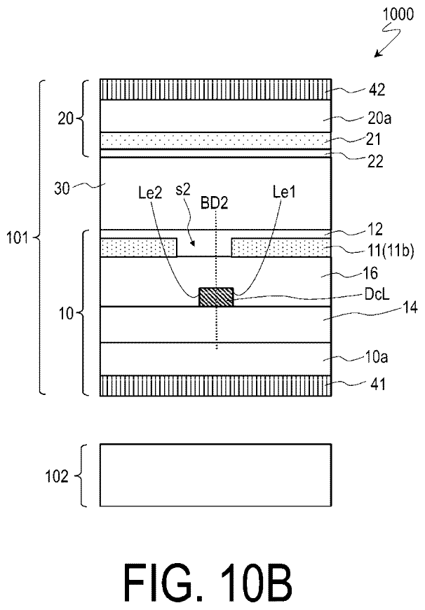

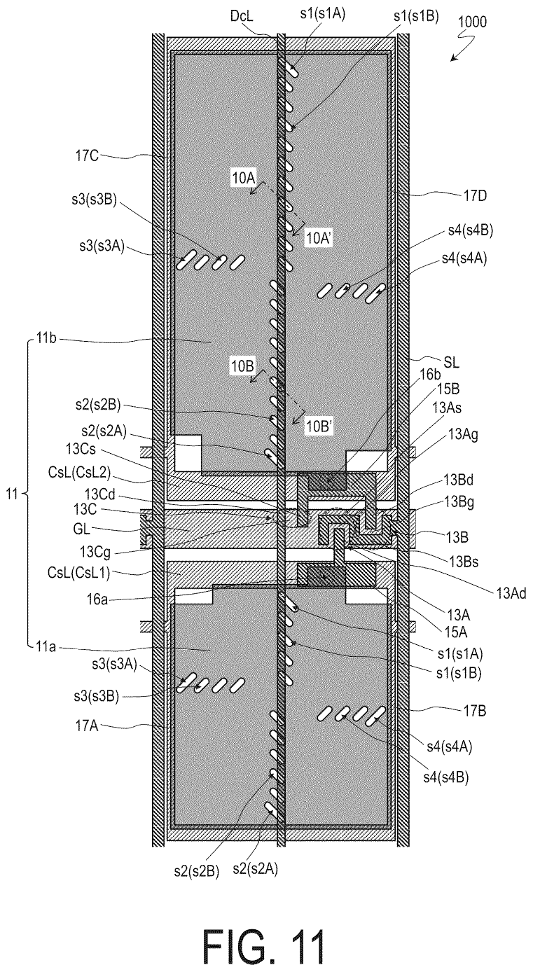

Furthermore, the liquid crystal display device 100 of the present embodiment includes the light blocking layer 18 arranged so as to at least partially overlap the plurality of first slits s1 and the plurality of second slits s2 in a plan view. An effect achieved by providing the above-mentioned light blocking layer 18 is described below in comparison to a liquid crystal display device 1000 in a comparative example illustrated in FIGS. 10A, 10B, and 11.

FIGS. 10A and 10B are cross-sectional views each illustrating the liquid crystal display device 1000 of a comparative example. FIG. 11 is a plan view illustrating the liquid crystal display device 1000 of the comparative example. FIGS. 10A and 10B illustrate a cross section taken along a line 10A-10A′ in FIG. 11, and a cross section taken along a line 10B-10B′, respectively.

The liquid crystal display device 1000 according to the comparative example differs from the liquid crystal display device 100 in that the liquid crystal display device 1000 includes no light blocking layer 18, as illustrated in FIGS. 10A, 10B, and 11. In the liquid crystal display device 1000 of the comparative example, light leakage may occur in the vicinity of the first slits s1 and the second slits s2 during black display, and the contrast ratio may decrease.

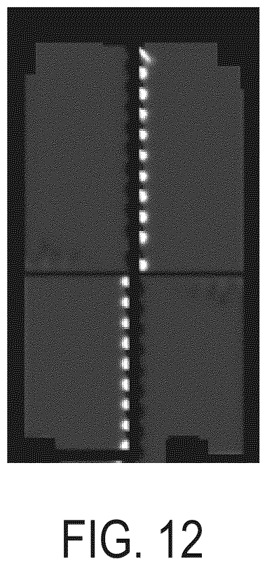

FIG. 12 is a diagram illustrating a result obtained by simulating a transmittance distribution in the second subpixel Sp2 during black display in the liquid crystal display device 1000 of the comparative example. From FIG. 12, it can be understood that light leakage occurs in the vicinity of the first slits s1 and the second slits s2. The above-described light leakage is caused by an unintended voltage applied to the liquid crystal layer 30 in the vicinity of the first slits s1 and the second slits s2 due to a difference between the potential applied to the discharge wiring line DcL and the potential applied to the counter electrode 21.

In contrast, in the liquid crystal display device 100 of the present embodiment, the light blocking layer 18 is arranged so as to at least partially overlap the plurality of first slits s1 and the plurality of second slits s2 in a plan view. Thus, it is possible to suppress light leakage in the vicinity of the first slits s1 and the second slits s2, and to suppress a decrease in contrast ratio.

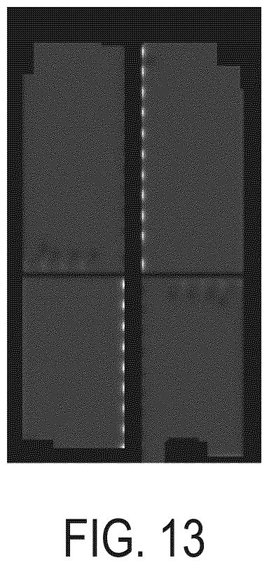

FIG. 13 is a diagram illustrating a result obtained by an alignment simulation of a transmittance distribution in the second subpixel Sp2 during black display in the liquid crystal display device 100 of the present embodiment. From FIG. 13, it can be understood that the light leakage in the vicinity of the first slits s1 and the second slits s2 is suppressed.

Table 1 shows an example of calculating the transmittance during white display, the transmittance during black display, and the contrast ratio in the liquid crystal display device 1000 of the comparative example and the liquid crystal display device 100 of the present embodiment. Table 1 shows relative values obtained when a value of the liquid crystal display device 1000 of the comparative example is defined as 100%.

From Table 1, it can be understood that, in the liquid crystal display device 100 of the present embodiment, the contrast ratio is improved, compared to the liquid crystal display device 1000 of the comparative example.

TABLE 1

| | Comparative | First |
|---|---|---|
| | Example | Embodiment |
| Transmittance during | 100% | 94% |
| white display | | |
| Transmittance during | 100% | 76% |
| black display | | |
| Contrast ratio | 100% | 123% |

Note that, if the light blocking layer 18 is formed of a conductive material, it is preferable to apply a predetermined potential (that is, not an electrically floating state) to the light blocking layer 18, as described as an example. When the light blocking layer 18 is in an electrically floating state, the potential of the light blocking layer 18 varies, and thus, the alignment in the liquid crystal layer 30 may be disrupted in the vicinity of the first slits s1 and the second slits s2.

### Second Embodiment

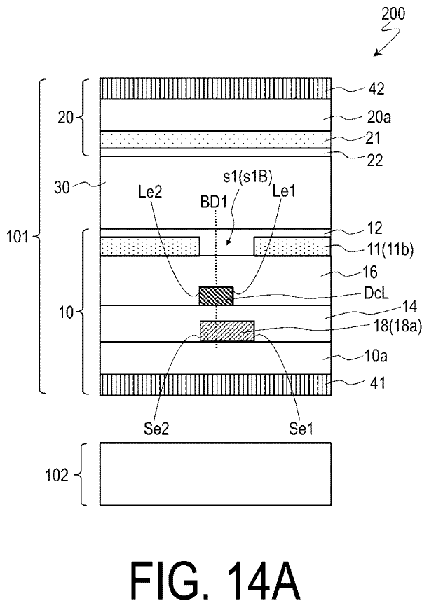

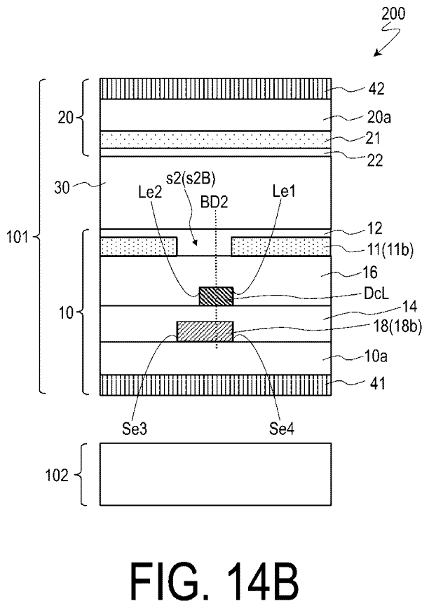

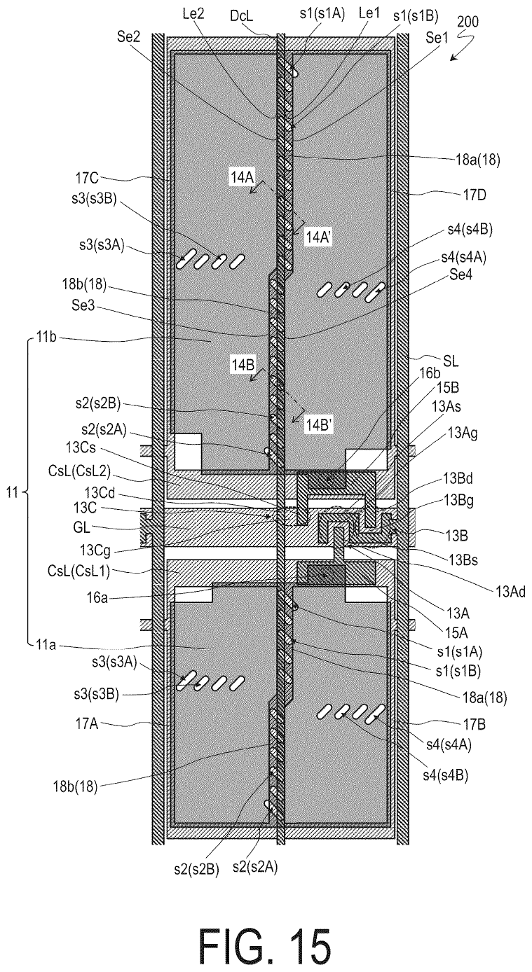

A liquid crystal display device 200 of the present embodiment will be described with reference to FIGS. 14A, 14B, and 15. FIGS. 14A and 14B are cross-sectional views each schematically illustrating the liquid crystal display device 200. FIG. 15 is a plan view schematically illustrating the liquid crystal display device 200. FIGS. 14A and 14B illustrate a cross section taken along a line 14A-14A′ in FIG. 15, and a cross section taken along a line 14B-14B′, respectively. The following description will primarily focus on differences of the liquid crystal display device 200 from the liquid crystal display device 100 of the first embodiment.

In the liquid crystal display device 100 of the first embodiment, the first light blocking portion 18a of the light blocking layer 18 is arranged so that the center of the first light blocking portion 18a in the width direction substantially coincides with the center of the discharge wiring line DcL in the width direction in a plan view. Furthermore, the second light blocking portion 18b of the light blocking layer 18 is also arranged so that the center of the second light blocking portion 18b in the width direction substantially coincides with the center of the discharge wiring line DcL in the width direction in a plan view.

In contrast, in the liquid crystal display device 200 of the present embodiment, the first light blocking portion 18a of the light blocking layer 18 is arranged so that the center of the first light blocking portion 18a in the width direction is shifted further to the first wiring line edge Le1 than the center of the discharge wiring line DcL in the width direction in a plan view, as illustrated in FIGS. 14A and 15. In the example illustrated in the drawings, each of the first short slits s1B among the plurality of first slits s1 entirely overlaps the first light blocking portion 18a in a plan view. The first long slit s1A includes a portion overlapping the first light blocking portion 18a and a portion not overlapping the first light blocking portion 18a in a plan view (that is, the first long slit s1A partially overlaps the first light blocking portion 18a).

As illustrated in FIGS. 14B and 15, the second light blocking portion 18b of the light blocking layer 18 is arranged so that a center of the second light blocking portion 18b in the width direction is shifted further to the second wiring line edge Le2 than the center of the discharge wiring line DcL in the width direction in a plan view. In the example illustrated in the drawings, each of the second short slits s2B of the plurality of second slits s2 entirely overlaps the second light blocking portion 18b in a plan view. The second long slit s2A includes a portion overlapping the second light blocking portion 18b and a portion not overlapping the second light blocking portion 18b in a plan view (that is, the second long slit s2A partially overlaps the second light blocking portion 18b).

As described above, compared with the liquid crystal display device 100 of the first embodiment, the liquid crystal display device 200 of the present embodiment has a configuration in which the first light blocking portion 18a is shifted toward the first wiring line edge Le1 of the discharge wiring line DcL and the second light blocking portion 18b is shifted toward the second wiring line edge Le2 of the discharge wiring line DcL. According to such a configuration, a protruding width of the first light blocking portion 18a from the first wiring line edge Le1 and a protruding width of the second light blocking portion 18b from the second wiring line edge Le2 can be increased, and thus, light leakage can be further suppressed.

Note that, the protruding width of the first light blocking portion 18a from the first wiring line edge Le1 and the protruding width of the second light blocking portion 18b from the second wiring line edge Le2 can also be increased by simply increasing the width of the first light blocking portion 18a and the width of the second light blocking portion 18b, while the center of the first light blocking portion 18a in the width direction and the center of the second light blocking portion 18b in the width direction substantially coincide with the center of the discharge wiring line DcL in the width direction. However, in this case, the light utilization efficiency may decrease. As in the present embodiment, by shifting the first light blocking portion 18a toward the first wiring line edge Le1 and shifting the second light blocking portion 18b toward the second wiring line edge Le2, the effect of suppressing light leakage can be enhanced, while suppressing a decrease in light utilization efficiency.

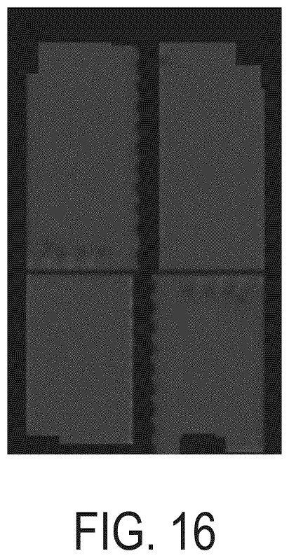

FIG. 16 is a diagram illustrating a result obtained by an alignment simulation of a transmittance distribution in the second subpixel Sp2 during black display in the liquid crystal display device 200 of the present embodiment. By comparing FIG. 16 and FIG. 13, it can be understood that, in the liquid crystal display device 200 of the present embodiment, light leakage in the vicinity of the first slits s1 and the second slits s2 is suppressed better than in the liquid crystal display device 100 of the first embodiment.

Table 2 shows an example of calculating the transmittance during white display, the transmittance during black display, and the contrast ratio in the liquid crystal display device 200 of the present embodiment. Note that, in the calculation, the width of the first light blocking portion 18a and the width of the second light blocking portion 18b are the same as the widths in the liquid crystal display device 100 of the first embodiment.

From Table 2, it can be understood that, in the liquid crystal display device 200 of the present embodiment, light leakage is further suppressed and the contrast ratio is further improved than in the liquid crystal display device 100 of the first embodiment.

TABLE 2

| | Comparative | First | Second |
|---|---|---|---|
| | Example | Embodiment | Embodiment |
| Transmittance during white | 100% | 94% | 92% |
| display | | | |
| Transmittance during black | 100% | 76% | 73% |
| display | | | |
| Contrast ratio | 100% | 123% | 127% |

From the viewpoint of suppressing a decrease in the light utilization efficiency, in a case in which the plurality of first slits s1 include the first long slit s1A and the first short slits s1B, as described above, it is preferable to adopt a configuration in which the first short slits s1B entirely overlap the first light blocking portion 18a and the first long slit s1A partially overlaps the first light blocking portion 18a. Similarly, in a case in which the plurality of second slits s2 include the second long slit s2A and the second short slits s2B, it is preferable to adopt a configuration in which the second short slits s2B entirely overlap the second light blocking portion 18b and the second long slit s2A partially overlaps the second light blocking portion 18b.

### Protruding Width of Light Blocking Layer

A result of verifying a preferable size of the protruding width of the light blocking layer 18 from the discharge wiring line DcL will be described.

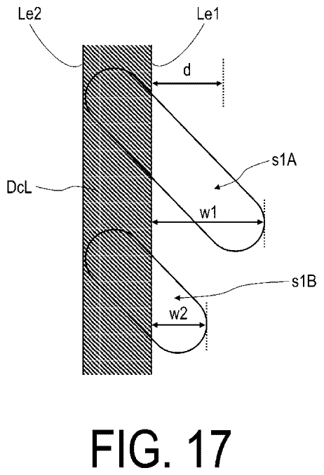

First, as illustrated in FIG. 17, a relationship between a distance d from the first wiring line edge Le1 of the discharge wiring line DcL and the luminance during black display (black luminance) (that is, the profile of the light leakage) was calculated and confirmed in the first long slit s1A and the first short slits s1B in a case in which the light blocking layer 18 is not provided. Here, the calculation was performed in a case in which a protruding width w1 of the first long slit s1A from the first wiring line edge Le1 is 7.3 μm and a protruding width w2 of each of the first short slits s1B is 3.5 μm.

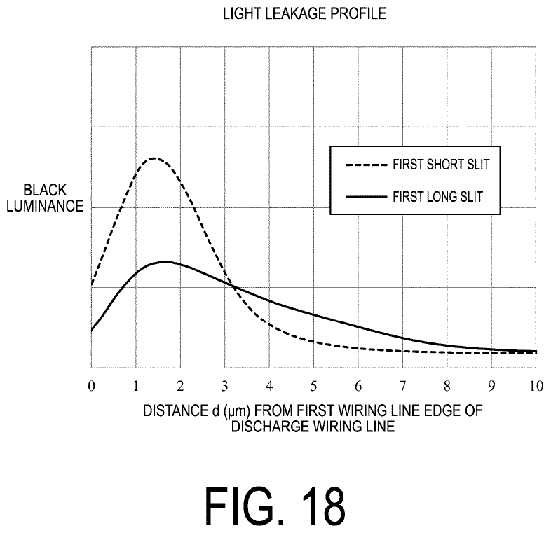

The obtained light leakage profile is shown in FIG. 18. From FIG. 18, it can be understood that, for both the first long slit s1A and the first short slit s1B, the light leakage is the largest when the distance d from the first wiring line edge Le1 is about 1.4 μm to 1.6 μm.

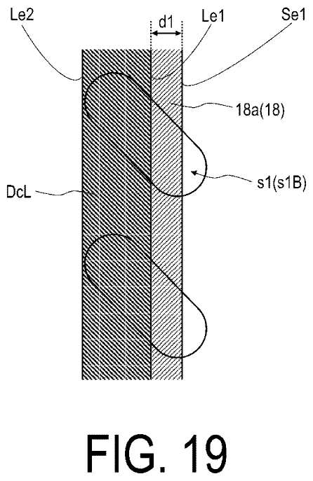

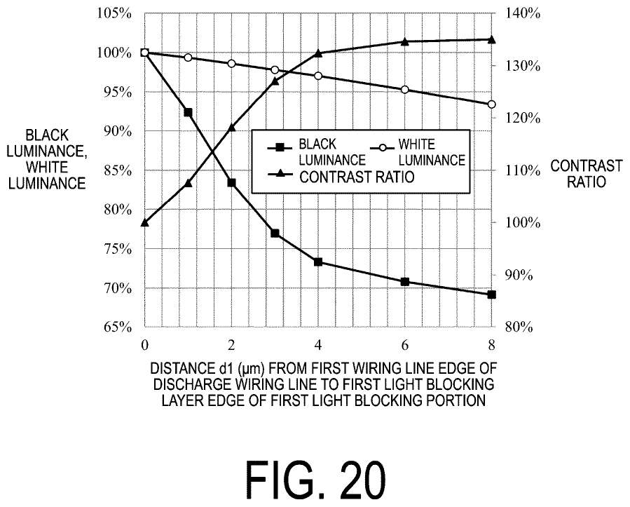

Subsequently, the black luminance, the white luminance, and the contrast ratio of the first short slit s1B in a case in which the light blocking layer 18 is provided are calculated and confirmed by changing a protruding width of the first light blocking portion 18a from a first wiring line edge Le1 of the discharge wiring line DcL. Here, the protruding width of the first light blocking portion 18a refers to a distance d1 from the first wiring line edge Le1 to the first light blocking layer edge Se1 of the first light blocking portion 18a in a plan view, as illustrated in FIG. 19. The confirmation results are shown in FIG. 20.

From FIG. 20, it can be understood that the black luminance decreases and the contrast ratio increases when the protruding width d1 of the first light blocking portion 18a is increased. The decrease in the black luminance tends to reach saturation when the protruding width d1 is 4 μm or greater, and the increase in the contrast ratio tends to reach saturation when the protruding width d1 is 4 μm or greater. Furthermore, from FIG. 20, it can be understood that the white luminance decreases (decreases substantially linearly) when the protruding width d1 of the first light blocking portion 18a is increased. This is because the aperture ratio is reduced. Therefore, it can be said that there is a trade-off relationship between the suppression of light leakage and the white luminance.

Considering that the peak in the light leakage profile shown in FIG. 18 is located around 1.4 μm to 1.6 μm, the protruding width d1 of the first light blocking portion 18a is preferably 1.4 μm or greater, in order to suppress light leakage.

Considering that the decrease in the black luminance and the increase in the contrast ratio tend to reach saturation, the protruding width d1 of the first light blocking portion 18a is preferably 4.0 μm or less, in order to maintain the white luminance sufficiently high.

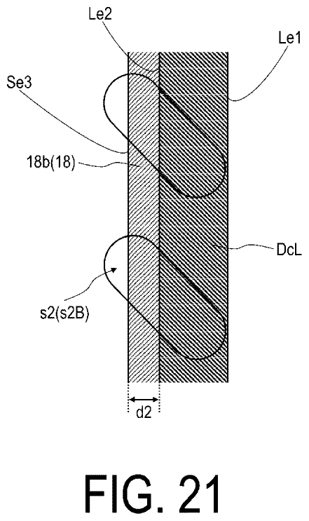

The above-described knowledge can be similarly applied to the protruding width of the second light blocking portion 18b from the second wiring line edge Le2 of the discharge wiring line DcL. Here, as illustrated in FIG. 21, the protruding width of the second light blocking portion 18b refers to a distance d2 from the second wiring line edge Le2 to the third light blocking layer edge Se3 of the second light blocking portion 18b in a plan view. In order to suppress light leakage, the protruding width d2 of the second light blocking portion 18b is preferably 1.4 μm or greater. In order to maintain the white luminance sufficiently high, the protruding width d2 of the second light blocking portion 18b is preferably 4.0 μm or less.

### Other Configurations

In the above description, a configuration in which the light blocking layer 18 is provided below the discharge wiring line DcL (that is, between the discharge wiring line DcL and the substrate 10a) is described as an example. However, the embodiment of the disclosure is not limited to the above-described configuration. The light blocking layer 18 may be provided above the discharge wiring line DcL (that is, between the discharge wiring line DcL and the liquid crystal layer 30).

In the above description, a configuration in which the active matrix substrate 10 includes the light blocking layer 18 is described as an example. However, the embodiment of the disclosure is not limited to the above-described configuration. The counter substrate 20 may include the light blocking layer 18. In a case in which the counter substrate 20 includes the light blocking layer 18, the light blocking layer 18 is formed in the same layer as a black matrix, for example. As described above, a configuration in which the active matrix substrate 10 includes the light blocking layer 18 is advantageous in that, even if a shift (bonding shift) occurs when the active matrix substrate 10 and the counter substrate 20 are bonded to each other, no positional offset of the light blocking layer 18 with respect to the first slit s1 and the second slit s2 is generated.

### INDUSTRIAL APPLICABILITY

According to the embodiment of the disclosure, for example, in a liquid crystal display device using a VA mode in which a pixel division drive technique using a discharge method is used and an alignment division structure is formed by using an alignment film to define a pretilt direction, a decrease in contrast ratio can be suppressed. The liquid crystal display device according to the embodiment of the disclosure is suitably used for applications that require high quality display, such as television receivers.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A liquid crystal display device, comprising:
a first substrate and a second substrate facing each other;
a vertically aligned liquid crystal layer provided between the first substrate and the second substrate; and
a plurality of pixels arrayed in a matrix shape including a plurality of pixel rows and a plurality of pixel columns,
wherein the first substrate includes a gate wiring line configured to supply a gate signal to a corresponding pixel row among the plurality of pixel rows, a source wiring line configured to supply a source signal to a corresponding pixel column among
the plurality of pixel columns, and a pixel electrode provided in each of the plurality of pixels,
the second substrate includes a counter electrode facing the pixel electrode,
each of the plurality of pixels includes a first subpixel and a second subpixel in which different voltages can be applied to the vertically aligned liquid crystal layer,
the pixel electrode includes a first subpixel electrode provided in the first subpixel and a second subpixel electrode provided in the second subpixel,
the first substrate includes
a first TFT electrically connected to the gate wiring line, the source wiring line, and the first subpixel electrode,
a second TFT electrically connected to the gate wiring line, the source wiring line, and the second subpixel electrode,
a third TFT electrically connected to the gate wiring line, the second TFT, and the second subpixel electrode, and
a discharge wiring line electrically connected to the third TFT,
the pixel electrode includes at least one slit that at least partially overlaps the discharge wiring line in a plan view, and
the first substrate or the second substrate includes a light blocking layer including a light blocking portion that at least partially overlaps the at least one slit in a plan view.

2. The liquid crystal display device according to claim 1,
wherein the at least one slit includes a portion overlapping both the light blocking portion and the discharge wiring line in a plan view, and a portion overlapping the light blocking portion and not overlapping the discharge wiring line in a plan view.

3. The liquid crystal display device according to claim 1,
wherein a potential applied to the discharge wiring line is different from a potential applied to the counter electrode.

4. The liquid crystal display device according to claim 1,
wherein the first substrate includes the light blocking layer.

5. The liquid crystal display device according to claim 4,
wherein the light blocking layer is formed of a conductive material and a predetermined potential is applied to the light blocking layer.

6. The liquid crystal display device according to claim 5,
wherein the first substrate further includes an auxiliary capacitor wiring line, and
the predetermined potential applied to the light blocking layer is identical to a potential applied to the auxiliary capacitor wiring line.

7. The liquid crystal display device according to claim 4,
wherein the discharge wiring line is formed in an identical layer to the source wiring line, and
the light blocking layer is formed in an identical layer to the gate wiring line.

8. The liquid crystal display device according to claim 1,
wherein the first substrate further includes a first alignment film provided between the pixel electrode and the liquid crystal layer,
the second substrate further includes a second alignment film provided between the counter electrode and the liquid crystal layer,
each of the first subpixel and the second subpixel includes a plurality of liquid crystal domains having different reference alignment directions defined by the first alignment film and the second alignment film,
the plurality of liquid crystal domains include a first liquid crystal domain in which the reference alignment direction is a first direction, a second liquid crystal domain in which the reference alignment direction is a second direction, a third liquid crystal domain in which the reference alignment direction is a third direction, and a fourth liquid crystal domain in which the reference alignment direction is a fourth direction,
the at least one slit includes at least one first slit extending substantially parallel to the first direction, the at least one first slit being located at or near a first boundary that is a boundary between the first liquid crystal domain and another one of the plurality of liquid crystal domains, and
the discharge wiring line overlaps the first boundary in a plan view.

9. The liquid crystal display device according to claim 8,
wherein the light blocking layer extends in a direction substantially identical to a direction in which the discharge wiring line extends,
the discharge wiring line includes a first wiring line edge and a second wiring line edge that define a width of the discharge wiring line, the first wiring line edge being located relatively closer to the first liquid crystal domain, and the second wiring line edge being located relatively closer to the other one of the plurality of liquid crystal domains,
the light blocking portion includes a first light blocking layer edge and a second light blocking layer edge that define a width of the light blocking portion, the first light blocking layer edge being located relatively closer to the first liquid crystal domain, and the second light blocking layer edge being located relatively closer to the other one of the plurality of liquid crystal domains, and
the first wiring line edge is located between the first boundary and the first light blocking layer edge.

10. The liquid crystal display device according to claim 9,
wherein the light blocking portion is disposed such that a center of the light blocking portion in a width direction is shifted further to the first wiring line edge than a center of the discharge wiring line in the width direction in a plan view.

11. The liquid crystal display device according to claim 9,
wherein a distance from the first wiring line edge to the first light blocking layer edge in a plan view is 1.4 μm or greater.

12. The liquid crystal display device according to claim 9,
wherein the distance from the first wiring line edge to the first light blocking layer edge in a plan view is 4.0 μm or less.

13. The liquid crystal display device according to claim 8,
wherein the at least one first slit includes a first long slit and at least one first short slit shorter than the first long slit.

14. The liquid crystal display device according to claim 13,
wherein each of the at least one first short slit entirely overlaps the light blocking portion in a plan view, and
the first long slit includes a portion overlapping the light blocking portion and a portion not overlapping the light blocking portion in a plan view.

15. The liquid crystal display device according to claim 8,
wherein the first liquid crystal domain, the second liquid crystal domain, the third liquid crystal domain, and the fourth liquid crystal domain are arranged in two rows and two columns,
the first liquid crystal domain and the second liquid crystal domain are adjacent to each other in an oblique direction inclined with respect to a row direction and a column direction,
the pixel electrode includes at least one second slit formed in a region corresponding to the second liquid crystal domain, the at least one second slit extending substantially parallel to the second direction and being located at or near a second boundary that is a boundary between the second liquid crystal domain and another one of the plurality of liquid crystal domains,
the discharge wiring line also overlaps the second boundary in a plan view, and
the light blocking layer includes a further light blocking portion that at least partially overlaps the at least one second slit in a plan view.

16. The liquid crystal display device according to claim 15,
wherein the third liquid crystal domain is adjacent to the first liquid crystal domain in the row direction and adjacent to the second liquid crystal domain in the column direction,
the fourth liquid crystal domain is adjacent to the first liquid crystal domain in the column direction and adjacent to the second liquid crystal domain in the row direction,
the first boundary is a boundary between the first liquid crystal domain and the third liquid crystal domain, and
the second boundary is a boundary between the second liquid crystal domain and the fourth liquid crystal domain.

17. The liquid crystal display device according to claim 8,
wherein the first direction, the second direction, the third direction, and the fourth direction are four directions in which a difference between any two directions is substantially equal to an integer multiple of 90°.

18. The liquid crystal display device according to claim 8,
wherein the first direction and the second direction form an angle of about 180°.

19. The liquid crystal display device according to claim 8,
wherein each of the first alignment film and the second alignment film is a photo-alignment film.
